(19) United States
(12) Patent Application Publication
(10) Pub. No.: US 2022/0318617 A1
(43) Pub. Date: Oct. 6, 2022

(54) PREDICTING FUTURE EVENTS OF PREDETERMINED DURATION USING ADAPTIVELY TRAINED ARTIFICIAL-INTELLIGENCE PROCESSES

(71) Applicant: The Toronto-Dominion Bank, Toronto (CA)

(72) Inventors: Anson Wah Chun WONG, Toronto (CA); Junwei MA, Toronto (CA); Maksims VOLKOVS, Toronto (CA); Tomi Johan POUTANEN, Toronto (CA)

(21) Appl. No.: 17/337,140

(22) Filed: Jun. 2, 2021

Related U.S. Application Data
(60) Provisional application No. 63/169,357, filed on Apr. 1, 2021.

(51) Int. Cl. G06N 3/08; G06K 9/62

(52) U.S. Cl. CPC G06N 3/08; G06K 9/623; G06K 9/6232; G06K 9/6262

(57) ABSTRACT

The disclosed embodiments include computer-implemented systems and methods that dynamically predict future occurrences of events using adaptively trained machine-learning or artificial-intelligence processes. For example, an apparatus may generate an input dataset based on elements of interaction data associated with an extraction interval. Based on an application of a trained artificial intelligence process to the input dataset, the apparatus may generate output data representative of a predicted likelihood of an occurrence of a first event during a first portion of a target interval, which may be separated from the extraction interval by a second portion of the target interval. The first event may be associated with a predetermined temporal duration within the first portion of the target interval. The apparatus may transmit a portion of the generated output data to a computing system, and the computing system may be configured to perform operations based on the portion of the output data.

### CROSS-REFERENCE TO RELATED APPLICATION

This application claims the benefit of priority under 35 U.S.C. § 119(e) to prior U.S. Application No. 63/169,357, filed Apr. 1, 2021, the disclosure of which is incorporated by reference herein to its entirety.

### TECHNICAL FIELD

The disclosed embodiments generally relate to computer-implemented systems and processes that facilitate a prediction of future events of predetermined duration using adaptively trained artificial intelligence processes.

### BACKGROUND

Today, financial institutions extend credit in the form of secured or unsecured credit products to their customers and in accordance with certain terms and conditions, such as a repayment schedule or corresponding interest rate. The terms and conditions associated with the secured or unsecured credit products may be established initially by the financial institutions prior to issuance and further, may be modified by the financial institutions based on an evolution in the relationships between the financial institutions and the customers, and based on the customer's use, or misuse, of various financial products issued by these financial institutions

### SUMMARY

In some examples, an apparatus includes a memory storing instructions, a communications interface, and at least one processor coupled to the memory and the communications interface. The at least one processor is configured to execute the instructions to generate an input dataset based on elements of interaction data associated with an extraction interval. The at least one processor is further configured to, based on an application of a trained artificial intelligence process to the input dataset, generate output data representative of a predicted likelihood of an occurrence of a first event during a first portion of a target interval. The target interval is subsequent to the extraction interval, the first portion of the target interval is separated from the extraction interval by a second portion of the target interval, and the first event is associated with a predetermined temporal duration within the first portion of the target interval. The at least one processor is further configured to transmit at least a portion of the generated output data to a computing system via the communications interface. The computing system is configured to perform operations based on the portion of the output data.

In other examples, a computer-implemented method includes generating, using at least one processor, an input dataset based on elements of interaction data associated with an extraction interval. The computer-implemented method also includes, based on an application of a trained artificial intelligence process to the input dataset, generating, using the at least one processor, output data representative of a predicted likelihood of an occurrence of a first event during a first portion of a target interval. The target interval is subsequent to the extraction interval, the first portion of the target interval is separated from the extraction interval by a second portion of the target interval, and the first event is associated with a predetermined temporal duration within the first portion of the target interval. The computer-implemented method also includes transmitting, using the at least one processor, at least a portion of the generated output data to a computing system. The computing system is configured to perform operations based on the portion of the output data.

Additionally, in some examples, a tangible, non-transitory computer-readable medium stores instructions that, when executed by at least one processor, cause the at least one processor to perform a method that includes generating an input dataset based on elements of interaction data associated with an extraction interval. The method also includes, based on an application of a trained artificial intelligence process to the input dataset, generating output data representative of a predicted likelihood of an occurrence of a first event during a first portion of a target interval. The target interval is subsequent to the extraction interval, the first portion of the target interval is separated from the extraction interval by a second portion of the target interval, and the first event is associated with a predetermined temporal duration within the first portion of the target interval. The method also includes transmitting at least a portion of the generated output data to a computing system. The computing system is configured to perform operations based on the portion of the output data.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1A, 1B, and 1C are block diagrams illustrating portions of an exemplary computing environment, in accordance with some exemplary embodiments.

FIGS. 1D, 1E, and 1F are diagrams of exemplary timelines for adaptively training a machine-learning or artificial intelligence process, in accordance with some exemplary embodiments.

FIGS. 2A and 2B are block diagrams illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of future events of predetermined duration based on an application of an adaptively trained machine-learning or artificial-intelligence process to input datasets, in accordance with some exemplary embodiments.

FIG. 5 is a flowchart of an exemplary process for mitigating occurrences of future events, in accordance with some exemplary embodiments.

Like reference numbers and designations in the various drawings indicate like elements.

### DETAILED DESCRIPTION

Modern financial institutions offer a variety of financial products or services to their customers, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of customer profile data identifying the customer and characterizing the customer's relationship with the financial institution, elements of account data identifying and characterizing one or more financial products issued to the customer by the financial institution, elements of transaction data identifying and characterizing one or more transactions involving these issued financial products, or elements of external reporting data, such as credit-bureau data associated with the particular customer. The elements of customer profile data, account data, transaction data, and/or reporting data may establish collectively a time-evolving risk profile for the customer, and the financial institution may base not only a decision to provision the particular financial product or service to the corresponding customer, but also a determination of one or more terms and conditions of the provisioned financial product or service, on the established risk profile.

The particular financial product may, for example, include a real estate secured lending (RESL) product, such as, but not limited to, one or more home mortgage products or one or more home-equity line-of-credit (HELOC) products, and the initial terms and conditions imposed on these RESL products may include, but are not limited to, an amount of credit extended to the customer, a repayment schedule, an amortization schedule, a fixed or variable interest rate, or a penalty imposed upon the customer by the financial institution in response to a determined violation of the initial terms or conditions. Further, in some examples, a customer that holds the RESL products may fail to submit a required payment to the financial institution in accordance with the corresponding repayment schedule (e.g., on or before a corresponding due date), and based on the failure to submit the required monthly payment, the RESL product held by the customer may become “past due,” e.g., as of the corresponding due date of the required monthly payment. The failure to submit the required monthly payment by the corresponding due date may, for example, represent an occurrence of a “delinquency event” involving the customer of the financial institution and the RESL product held by that customer, and the delinquency event may remain pending until resolution by the customer or by the financial institution. Examples of potential resolutions may include, among other things, a repayment of a past-due balance by the customer, by a settlement negotiated between the financial institution and the customer, a personal bankruptcy filing by the customer, or a write-off of a past-due balance by the financial institution.

The customer's failure to submit the required monthly payment may result from carelessness or a lapse of memory on the part of the customer, or may be indicative of financial distress on the part of the customer. Furthermore, the underlying causes of the occurrence of the delinquency event may be indicative of a speed and an ease at which the delinquency event is resolved by the customer and the financial institution, either individually or through collection action. By way of example, for a missed payment resulting from a mere lapse of memory on the part of the customer, the associated delinquency event may be resolved rapidly and without significant intervention by the financial institution. Alternatively, if the delinquency event were triggered by the customer's financial distress, an early and significant intervention by the financial institution, e.g., through the application of one or more appropriate treatments, may be necessary to resolve the delinquency event or to reduce an exposure of the financial institution to losses resulting from the delinquency event.

In some examples, to mitigate an exposure of the financial institution to losses from delinquency events involving a variety of RESL products, one or more computing systems of the financial institution may perform operations that, in real-time and contemporaneously with the occurrence of each of the delinquency events (e.g., the missed payments, etc.), characterize a credit exposure or a credit risk associated with each of the delinquency events, determine an expected timeline for resolving each of the delinquency events, and identify one or more appropriate treatments that, when applied to corresponding ones of the delinquency events, resolve the delinquency event or reduce a potential financial impact of the delinquency event on the financial institution.

The determination of the expected timeline for resolving each of the delinquency events may, in many instances, depend on the underlying, customer-specific events that trigger the delinquency events, such as memory lapse of financial distress, and many existing rules-based processes implemented by the computing systems of the financial institution to characterize the expected resolution time and identify the appropriate treatment rely on coarse, global metrics of customer behavior, such as the customer's credit score or payment history, and not on inferences based on the customer's saving, spending, or purchasing habits that could separate true financial distress from mere forgetfulness. Additionally, these rules-based processes are often implemented upon detection of an occurrence of corresponding delinquency event, and may be incapable of analyzing, or accounting for, changes in customer behavior prior to the detected occurrence of the delinquency event.

Further, many existing adaptive techniques for discerning the underlying, customer-specific events that trigger the delinquency events may be specific to certain credit products, or types of credit products, and may require an iterative application to corresponding sets of input data characterizing one or more delinquency events involving the specific credit products, or specific types of credit products. The computational time required to adaptively train and deploy these adaptive techniques (e.g., machine-learning processes, artificial-intelligence processes, stochastic statistical processes, etc.) for a single credit product or a single type of credit product, when repeated across the variety of credit products and types of credit products issued by the financial institution, may render impractical any discernment of the underlying, customer-specific events that trigger the predicted default events. Further, as these adaptive techniques are often trained against elements of training data that characterize an initial occurrence of a delinquency event, these existing adaptive techniques may be inappropriate for deployment against input datasets characterizing changes in customer behavior prior to the initial occurrence.

In some examples, described herein, a machine-learning or artificial-intelligence process may be adaptively trained to predict (i) a non-occurrence of a delinquency event involving a customer of the financial institution and an issued RESL product during a first portion of a future, target temporal interval and (ii) an occurrence of a default event involving the customer of the financial institution and the issued RESL product during a second portion of the future, target temporal interval. By way of example, a delinquency event involving the customer of the financial institution and the issued RESL product occurs when the customer fails to submit a scheduled payment associated with issued RESL product (e.g., when that scheduled payment becomes “past due”), and as described herein, a default event occurs during the second portion of the target temporal interval when, during the second portion of the target temporal interval, the customer fails to submit a scheduled payment associated with issued RESL product and the scheduled payment remains past due for at least a predetermined threshold interval.

As described herein, the machine-learning or artificial-intelligence process may include an ensemble or decision-tree process, such as a gradient-boosted decision-tree process (e.g., XGBoost Binary Classifier model), and certain of the exemplary training and validation processes described herein may generate, and utilize, training datasets associated with a first prior temporal interval (e.g., a “training” interval), and using validation datasets associated with a second, and distinct, prior temporal interval (e.g., an out-of-time “validation” interval). Further, and based on an application of the trained, gradient-boosted decision-tree process to input datasets characterizing customers of the financial institution that hold non-delinquent RESL products, certain of the exemplary processes may generate customer-specific elements of output data, each of which include a numerical score indicative of a predicted likelihood (e.g., a risk) that a corresponding one of the customers, and a corresponding one or the non-delinquent RESL products, will be involved in an early-stage delinquency during the future, target temporal interval.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more computing systems of the financial institution to predict, for a customer of the financial institution that holds a non-delinquent RESL product, a likelihood of an occurrence an early-stage delinquency during a future, target temporal interval. Through an implementation of one or more of these exemplary processes, the one or more computing systems of the financial institution may establish that the customer is at risk for early stage delinquency prior to the occurrence of an actual delinquency event (e.g., the missed payment, etc.) and further, that the customer represents a candidate for an application of one or more product-specific treatments, which may mitigate the customer's risk of the early-stage delinquency or reduce an exposure of the financial institution to the early-stage delinquency. These exemplary processes may, for example, be implemented in addition to, or as alternative to, existing processes through which the one or more computing systems implement rules-based processes that analyze the coarse metrics of customer behavior, or that apply adaptively trained, product-specific processes to input datasets, in response to a detected delinquency event involving a corresponding RESL product.

### A. Exemplary Processes for Adaptively Training Gradient-Boosted, Decision Tree Processes in a Distributed Computing Environment

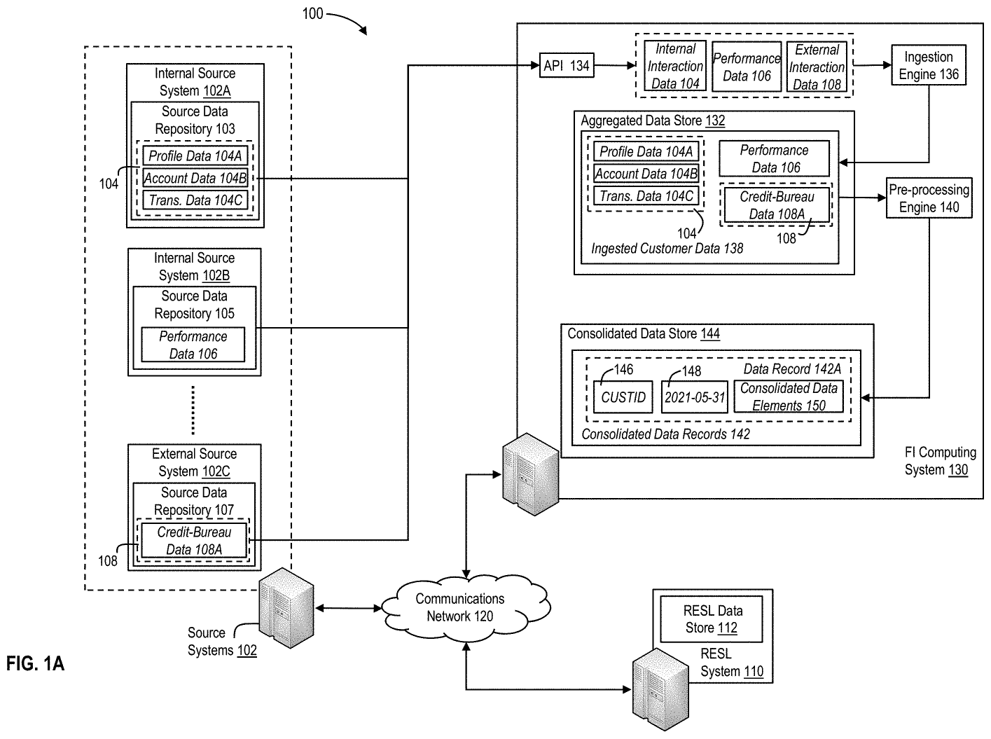

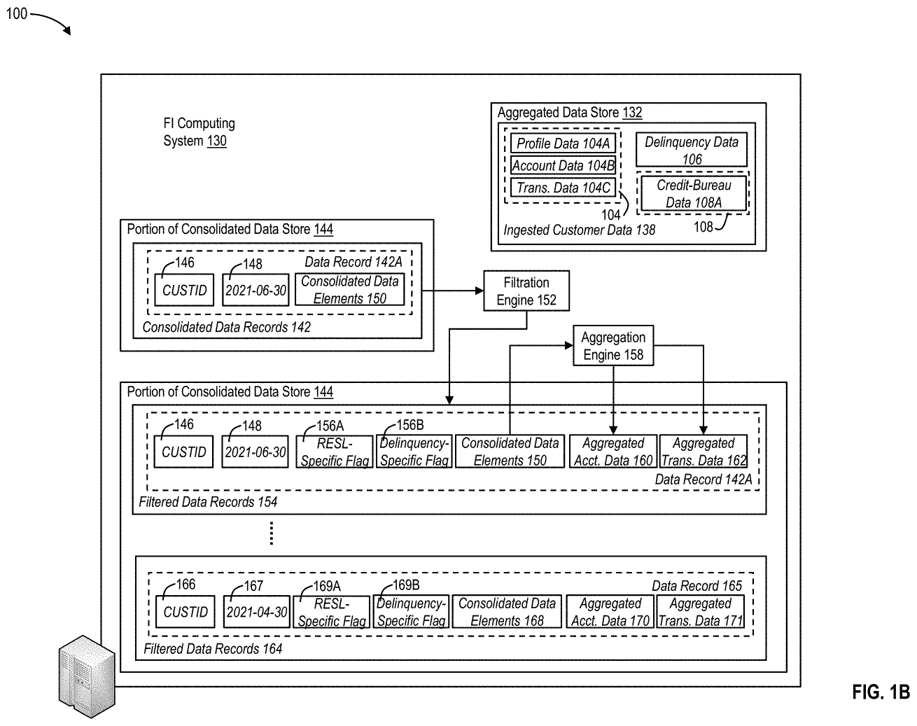

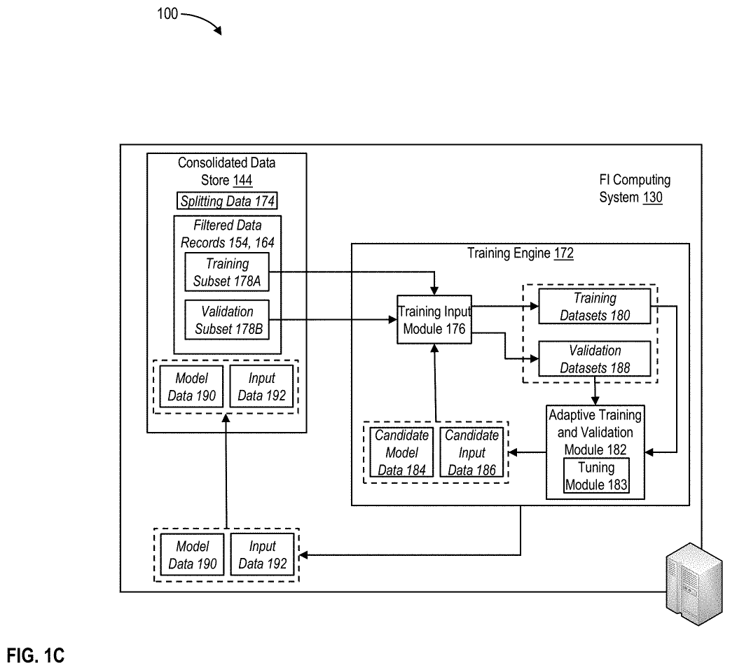

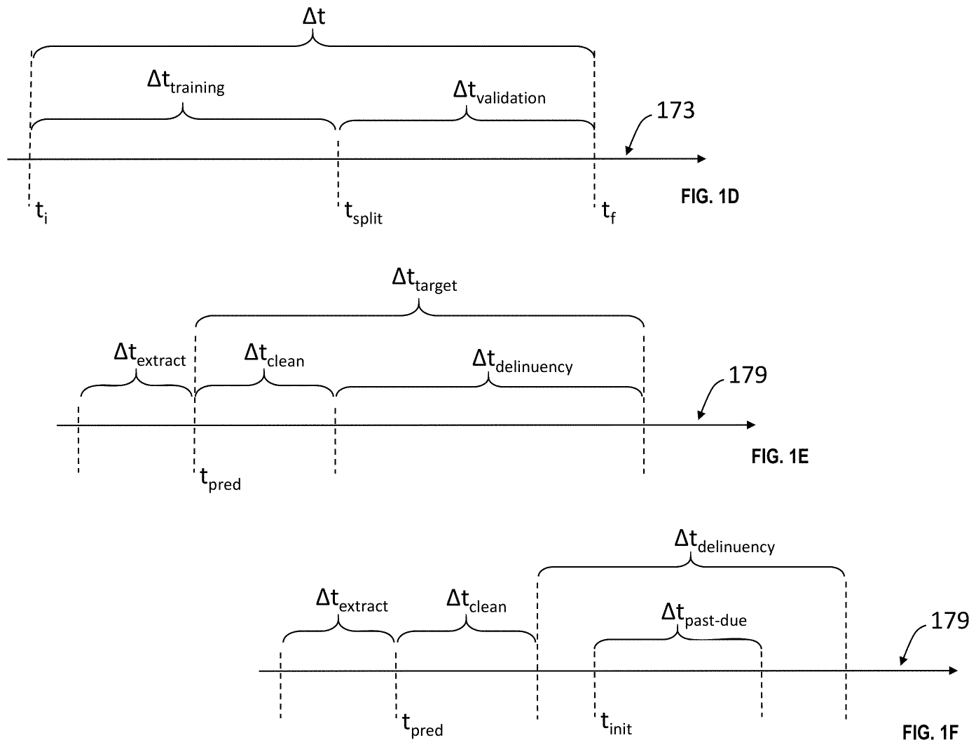

FIGS. 1A, 1B, and 1C illustrate components of an exemplary computing environment 100, in accordance with some exemplary embodiments. For example, as illustrated in FIG. 1A, environment 100 may include one or more source systems 102, such as, but not limited to, internal source system 102A, internal source system 102B, and external source system 102C and one or more computing systems associated with, or operated by, a financial institution, such as RESL computing system 110 and financial institution (FI) computing system 130. In some instances, each of source systems 102 (including internal source system 102A, internal source system 102B, and external source system 102C), RESL computing system 110, and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including internal source system 102A, internal source system 102B, and external source system 102C), RESL computing system 110, and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including internal source system 102A, internal source system 102B, and external source system 102C), RESL computing system 110, and FI computing system 130 may also include a communications interface, such as one or more wireless transceivers, coupled to the one or more processors for accommodating wired or wireless internet communication with other computing systems and devices operating within environment 100.

Further, in some instances, source systems 102 (including internal source system 102A, internal source system 102B, and external source system 102C), RESL computing system 110, and FI computing system 130 may each be incorporated into a respective, discrete computing system. In additional, or alternate, instances, one or more of source systems 102 (including internal source system 102A and external source system 102C), RESL computing system 110, and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™, Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, in accordance with a predetermined temporal schedule, to ingest elements of data associated with the customers of the financial institution, to preprocess the ingested data elements by filtering, aggregating, and/or consolidating certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to customer-specific input datasets. Based on the application of the adaptively trained machine learning or artificial intelligence process to the customer-specific input datasets, the distributed components of FI computing system 130 may perform operations that generate customer-specific elements of output data indicative of a predicted likelihood (e.g., a risk) that a corresponding one of the customers, and a corresponding one or the non-delinquent RESL products, will be involved in an early-stage delinquency during the future, target temporal interval.

Referring back to FIG. 1A, each of source systems 102 may maintain, within corresponding tangible, non-transitory memories, a data repository that includes confidential data associated with the customers of the financial institution, and RESL computing system 110 may maintain a RESL data store 112 within a portion of one or more tangible, non-transitory memories. For example, internal source system 102A may be associated with, or operated by, the financial institution, and may maintain, within the corresponding one or more tangible, non-transitory memories, a source data repository 103 that includes one or more elements of internal interaction data 104. In some instances, internal interaction data 104 may include data that identifies or characterizes one or more customers of the financial institution and interactions between these customers and the financial institution, and examples of the confidential data include, but are not limited to, customer profile data 104A, account data 104B, and transaction data 104C.

In some instances, customer profile data 104A may include a plurality of data records associated with, and characterizing, corresponding ones of the customers of the financial institution. By way of example, and for a particular customer of the financial institution, the data records of customer profile data 104A may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution. Further, customer profile data 104A may also include, for the particular customer, multiple data records that include corresponding elements of temporal data (e.g., a time or date stamp, etc.), and the multiple data records may establish, for the particular customer, a temporal evolution in the customer residence or a temporal evolution in one or more of the demographic parameter values.

Account data 1048 may also include a plurality of data records that identify and characterize one or more financial products or instruments issued by the financial institution to corresponding ones of the customers. For example, the data records of account data 1048 may include, for each of the financial products issued to corresponding ones of the customers, one or more identifiers of the issued financial product or instrument (e.g., an account number, expiration data, card-security-code, etc.), one or more unique customer identifiers (e.g., an alphanumeric character string, such as a login credential, a customer name, etc.), information identifying a product type that characterizes the issued financial product or instrument, and additional information characterizing a balance or current status of the financial product or instrument (e.g., payment due dates or amounts, delinquent accounts statuses, etc.).

Examples of the issued financial products or instruments, and their corresponding product types, may include, but are not limited to, a demand deposit account (e.g., a savings account, a checking account, etc.), a term deposit account (e.g., a certificate of deposit), an investment or brokerage account, a retirement account, and one or more credit products, such as an unsecured or a secured credit product. In some instances, examples of the unsecured credit products issued by the financial institution, and their corresponding product types, may include, among other things, a credit-card account, an unsecured personal loan, an unsecured line-of-credit, and an overdraft protection (ODP) product, etc. Further, and as described herein, examples of the secured credit products issued by the financial institution, and their corresponding product may include, among other things, a secured line-of-credit, an auto loan, and one or more real estate secured lending (RESL) products, such as, but not limited to, a home mortgage product or a home-equity line-of-credit (HELOC). In some instances, and in addition to specifying the one or more identifiers of the secured or unsecured credit products, the one or more unique customer identifiers of the customers that hold the secured or unsecured credit products, and the additional information characterizing the balance or current status of the secured or unsecured credit products, the data records of account data 104B may also identify, for each of the secured or unsecured credit products, one or more terms and conditions that include, but are not limited to, an amount of credit extended to the corresponding customer, a repayment schedule, an interest rate, or a penalty imposed upon the corresponding customer by the financial institution in response to a determined violation of the terms or conditions.

In some instances, the data records of account data 1048 may establish, for one or more of the customers (e.g., via a corresponding one of the unique customer identifiers), summary information that identifies and summarizes each of the financial products issued to the corresponding one of the customers by the financial institution, and held by the customers, during one or more temporal intervals (e.g., those financial products “owned” by the corresponding one of the customers during the current temporal inter). Further, and for each of the one or more customers, the summary information may also identify and characterize a flow of funds into, or out of, each of the issued and held financial products during the one or more temporal intervals, along with insurance coverages, access services, and in some instances, authorized credit, associated with each of the issued and held financial products during the one or more temporal intervals. The summary information may, in some examples, establish a relationship between the one or more customers and the issued and held financial products during a current temporal interval, and may further characterize a temporal evolution of not only the interaction of these customers with the issued and held financial products, but also the characteristics of the issued and held financial products, during one or more prior temporal intervals.

Transaction data 104C may include data records that identify, and characterize, one or more initiated, settled, or cleared transactions involving respective ones of the customers of the financial institution and corresponding ones of the financial products or instruments issued by the financial institution, such as those described herein. Examples of these transactions include, but are not limited to, purchase transactions, payment transactions, electronic funds transfers, currency conversions, purchases of securities, derivatives, or other tradeable instruments, electronic funds transfer (EFT) transactions, peer-to-peer (P2P) transfers or transactions, or real-time payment (RTP) transactions. For instance, and for a particular one of the transactions, the data records of transaction data 104C may include information that identifies, among other things: a corresponding one of the customers (e.g., an alphanumeric customer identifier, etc.); a counterparty to the particular transaction (e.g., a counterparty name, a counterparty identifier, etc.); an identifier of a financial product or instrument involved in the particular transaction and held by the corresponding customer (e.g., a portion of a tokenized or actual account number, bank routing number, an expiration date, a card security code, etc.); and values of one or more parameters that characterize the particular transaction. In some instances, the transaction parameters may include, but are not limited, to a transaction amount associated with the particular transaction, a transaction date or time, an identifier of one or more products or services involved in the purchase transaction (e.g., a product name, a universal product code (UPC), etc.), or additional information describing the counterparty, such as a counterparty location, a standard industrial classification (SIC) code, or a merchant classification code (MCC) associated with the corresponding counterparty.

Further, as illustrated in FIG. 1A, internal source system 102B may also be associated with, or operated by, the financial institution, and may maintain, within the corresponding one or more tangible, non-transitory memories, a source data repository 105 that includes one or more elements credit performance data 106. In some instances, credit performance data 106 may include a plurality of data records, and each of the data records may be associated a corresponding one of the secured or unsecured credit products issued by the financial institution to a corresponding one of the customers. By way of example, the data records of credit performance data 106 may characterize, for corresponding ones of the secured or unsecured credit products, an adherence of a corresponding one of the customers to the associated terms and conditions, including the imposed repayment schedule, and may further characterize, for the corresponding ones of the secured or unsecured credit products, an occurrence of a pending or prior delinquency event involving corresponding ones of the customers (e.g., triggered by a missed payment, a payment inconsistent with the payment schedule, etc.). In some instances, the one or more processors of internal source system 102B may perform operations that update the data records of credit performance data 106 in accordance with a predetermined temporal schedule (e.g., on a monthly basis, etc.) to reflect changes in a customer adherence to the terms and conditions of the issued secured or unsecured credit products.

By way of example, each of the data records of credit performance data 106 may include information identifying a corresponding one of the secured or unsecured credit products issued by the financial institution (e.g., a product type, a portion of a tokenized or actual account number, bank routing number, an expiration date, a card security code, etc.), a unique identifier of a customer that holds the corresponding issued secured or unsecured credit product (e.g., an alphanumeric identifier or login credential, a customer name, etc.), and information characterizing an adherence to the customer to the terms and conditions associated with the corresponding issued secured or unsecured credit product (e.g., data, such as a flag, indicating that the customer is currently submitting timely payments, indicating that the customer is associated with a prior, resolved delinquency event, and/or indicating that the customer is involved in an ongoing, pending delinquency event).

Further, and for a secured or unsecured credit product, such as a home mortgage or a HELOC product associated with a prior or pending delinquency involving a corresponding one of the customers, the corresponding data records of credit performance data 106 may also include data characterizing the occurrence of the delinquency event (e.g., a time or date of a missed or insufficient payment, etc.), a past-due period associated with the delinquency event (e.g., a temporal interval between a current date or time and the time or date of a missed or insufficient payment, etc.), and a past-due balance associated with the delinquency event (e.g., including principal, interest, and any fees, etc.). In some instances, the corresponding data records of credit performance data 106 may also include, for the occurrence of the delinquency event, information that identifies one or more treatments implemented by the financial institution to resolve the delinquency event, and further temporal data that specifies a time or date on which the financial instruction implemented corresponding ones of the treatments.

By way of example, the one or more treatments may include, but are not limited to, generating and provisioning, to the corresponding customer, physical or electronic correspondence regarding the corresponding occurrence of the delinquency event (e.g., a physical letter, an email, a text-message, or an in-app notification, etc.), initiating voice-based communications with the corresponding customer (e.g., via a pre-recorded message delivered by telephone, via a call manually generated by a representative of the financial institution), or a modification to the terms or conditions associated with the secured or unsecured credit product involved in the delinquency event. Further, in some instances, the corresponding data records of credit performance data 106 may include additional temporal data characterizing a resolution of the delinquency event by the financial institution or the customer (e.g., a time or date of resolution, etc.).

The disclosed embodiments are, however, not limited to these exemplary elements of customer profile data 104A, account data 104B, and transaction data 104C, or to these exemplary elements of credit performance data 106. In other instances, the data records of internal interaction data 104 may include any additional or alternate elements of data that identify and characterize the customers of the financial institution and their relationships or interactions with the financial institution, financial products and instruments issued to these customers by the financial institution, and transactions involving respective ones of the customers and corresponding ones of the issued financial products or instruments described herein, and the data records of credit performance data 106 may include any additional, or alternate, information identifying and characterizing an adherence of customers of the financial institution to the terms and conditions of the issued secured or unsecured credit products, or identifying and characterizing occurrences of the pending or prior delinquency events, the involved customers, and issued secured or unsecured credit products. Further, although stored in FIG. 1A within data repositories maintained by internal source systems 102A and 102B, the exemplary elements of customer profile data 104A, account data 104B, and transaction data 104C, and the exemplary elements of credit performance data 106, may be maintained by any additional or alternate computing system associated with the financial institution, including, but not limited to, within one or more tangible, non-transitory memories of FI computing system 130.

External source system 102C may be associated with, or operated by, one or more judicial, regulatory, governmental, or reporting entities external to, and unrelated to, the financial institution, and external source system 102C may maintain, within the corresponding one or more tangible, non-transitory memories, a source data repository 107 that includes one or more elements of external interaction data 108. In some instances, external source system 102C may be associated with, or operated by, a reporting entity, such as a credit bureau, and external interaction data 108 may include data records that specify elements of credit-bureau data 108A associated with one or more customers of the financial institution. In some instances, the elements of credit-bureau data 108A for a customer of the financial institution may include, but are not limited to, a unique identifier of the customer (e.g., an alphanumeric identifier or login credential, a customer name, etc.), information identifying one or more financial products or instruments currently or previously held by the customer, information identifying a history of payments associated with these financial products or instruments, information identifying negative events associated with the customer (e.g., missed payments, collections, repossessions, etc.), a credit rating or score associated with the customer, and/or information identifying one or more credit inquiries involving the customer (e.g., inquiries by the financial institution, other financial institutions or business entities, etc.). The disclosed embodiments are, however, not limited to these exemplary elements of external interaction data 108, and in other instances, external interaction data 108 may include any additional or alternate elements of data associated with the customer and generated by the judicial, regulatory, governmental, or regulatory entities described herein, such as additional, or alternate, elements of credit-bureau data.

In some instances, FI computing system 130 may perform operations that establish and maintain one or more centralized data repositories within a corresponding ones of the tangible, non-transitory memories. For example, as illustrated in FIG. 1A, FI computing system 130 may establish an aggregated data store 132, which maintains, among other things, elements of the customer profile, account, transaction, delinquency, and credit-bureau data associated with one or more of the customers of the financial institution, which may be ingested by FI computing system 130 (e.g., from one or more of source systems 102) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 102, including internal source system 102A, internal source system 102B, and external source system 102C, across communications network 120, and may perform operations that access and obtain all, or a selected portion, of the elements of customer profile, account, transaction, delinquency, and/or reporting data maintained by corresponding ones of source systems 102. As illustrated in FIG. 1A, internal source system 102A may perform operations that obtain all, or a selected portion, of internal interaction data 104, including the data records of customer profile data 104A, account data 104B, and transaction data 104C, from source data repository 103, and transmit the obtained portions of internal interaction data 104 across communications network 120 to FI computing system 130. Further, internal source system 102B may also perform operations that obtain all, or a selected portion, of credit performance data 106 from source data repository 105, and transmit the obtained portions of credit performance data 106 across communications network 120 to FI computing system 130. Additionally, in some instances, external source system 102C may also perform operations that obtain all, or a selected portion, of external interaction data 108, including the data records of credit-bureau data 108A, from source data repository 107, and transmit the obtained portions of external interaction data 108 across communications network 120 to FI computing system 130.

In some instances, and prior to transmission across communications network 120 to FI computing system 130, internal source system 102A, internal source system 102B, and external source system 102C may encrypt respective portions of internal interaction data 104 (including the data records of customer profile data 104A, account data 104B, and transaction data 104C), credit performance data 106, and external interaction data 108 (including the data records of credit-bureau data 108A) using a corresponding encryption key, such as, but not limited to, a corresponding public cryptographic key associated with FI computing system 130. Further, although not illustrated in FIG. 1A, each of source systems 102 may perform any of the exemplary processes described herein to obtain, encrypt, and transmit additional, or alternate, portions of the locally maintained customer profile, account, transaction, delinquency, or credit-bureau data maintained across communications network 120 to FI computing system 130.

A programmatic interface established and maintained by FI computing system 130, such as application programming interface (API) 134, may receive the portions of internal interaction data 104 (including the data records of customer profile data 104A, account data 104B, and transaction data 104C) from internal source system 102A, credit performance data 106 from internal source system 102B, and external interaction data 108 (including the data records of credit-bureau data 108A) from external source system 102C. As illustrated in FIG. 1A, API 134 may route the portions of internal interaction data 104 (including the data records of customer profile data 104A, account data 104B, and transaction data 104C), credit performance data 106, and external interaction data 108 (including the data records of credit-bureau data 108A) to a data ingestion engine 136 executed by the one or more processors of FI computing system 130. As described herein, the portions of internal interaction data 104, credit performance data 106, and external interaction data 108 (and the additional, or alternate, portions of the customer profile, account, transaction, credit performance, or reporting data) may be encrypted, and executed data ingestion engine 136 may perform operations that decrypt each of the encrypted portions of internal interaction data 104, credit performance data 106, and external interaction data 108 (and the additional, or alternate, portions of the customer profile, account, transaction, credit performance, or reporting data) using a corresponding decryption key, e.g., a private cryptographic key associated with FI computing system 130.

Executed data ingestion engine 136 may also perform operations that store the portions of internal interaction data 104 (including the data records of customer profile data 104A, account data 104B, and transaction data 104C), credit performance data 106, and external interaction data 108 (including the data records of credit-bureau data 108A) within aggregated data store 132, e.g., as ingested customer data 138. As illustrated in FIG. 1A, a pre-processing engine 140 executed by the one or more processors of FI computing system 130 may access the elements of ingested customer data 138, and perform any of the exemplary data-processing operations described herein to pre-process the accessed elements of ingested customer data 138 and to generate consolidated data records 142 that characterize corresponding ones of the customers, their interactions with the financial institution and with other financial institutions, and an occurrence or non-occurrence associated delinquency events during a temporal interval associated with the ingestion of internal interaction data 104, credit performance data 106, and external interaction data 108 by executed data ingestion engine 136.

By way of example, executed pre-processing engine 140 may access the data records of customer profile data 104A, account data 104B, transaction data 104C, credit performance data 106, and/or credit-bureau data 108A, e.g., as maintained within ingested customer data 138). As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which FI computing system 130 ingests the elements of internal interaction data 104, credit performance data 106, and external interaction data 108. For example, executed data ingestion engine 136 may receive elements of confidential customer data from corresponding ones of source systems 102 on a monthly basis (e.g., on the final day of the month), and in particular, may receive and store the elements of internal interaction data 104, credit performance data 106, and external interaction data 108 from corresponding ones of source systems 102 on Jun. 30, 2021.

Executed pre-processing engine 140 may generate a temporal identifier associated with the regular, monthly ingestion of internal interaction data 104, credit performance data 106, and external interaction data 108 on Jun. 30, 2021 (e.g., “2021-06-30”), and may augment the accessed data records of customer profile data 104A, account data 104B, transaction data 104C, credit performance data 106, and/or credit-bureau data 108A to include the generated temporal identifier. The disclosed embodiments are, however, not limited to temporal identifiers reflective of a monthly ingestion of internal interaction data 104, credit performance data 106, and external interaction data 108 by FI computing system 130, and in other instances, executed pre-processing engine 140 may augment the accessed data records to include temporal identifiers reflective of any additional, or alternative, temporal interval during which FI computing system 130 ingests the elements of internal interaction data 104, credit performance data 106, and external interaction data 108.

In some instances, executed pre-processing engine 140 may perform further operations that, for a particular customer of the financial institution during the temporal interval (e.g., represented by a pair of the customer and temporal identifiers described herein), obtain one or more data records of customer profile data 104A, account data 104B, transaction data 104C, credit performance data 106, and credit-bureau data 108A that include the pair of customer and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular customer of the financial institution across the temporal interval. By way of example, executed pre-processing engine 140 may consolidate the obtained data records, which include the pair of customer and temporal identifiers, through an invocation of an appropriate Java-based SQL “join” command (e.g., an appropriate “inner” or “outer” join command, etc.).

Further, executed pre-processing engine 140 may perform any of the exemplary processes described herein to generate another one of consolidated data records 142 for each additional, or alternate, customer of the financial institution during the temporal interval (e.g., as represented by a corresponding customer identifier and the temporal interval). In some instances, executed pre-processing engine 140 may perform operations that store each of consolidated data records 142 within one or more tangible, non-transitory memories of FI computing system 130, such as consolidated data store 144. Consolidated data store 144 may, for example, correspond to a data lake, a data warehouse, or another centralized repository established and maintained, respectively, by the distributed components of FI computing system 130, e.g., through the HDFS described herein.

In some instances, consolidated data records 142 may include a plurality of discrete data records, and each of these discrete data records may be associated with, and may maintain data characterizing, a corresponding one of the customers of the financial institution during the corresponding temporal interval (e.g., a month-long interval extending from Jun. 1, 2021, to Jun. 30, 2021). By way of example, and for a particular customer of the financial institution, discrete data record 142A of consolidated data records 142 may include a customer identifier 146 of the particular customer (e.g., an alphanumeric character string “CUSTID”), a temporal identifier 148 of a corresponding temporal interval (e.g., a numerical string “2021-06-30”), and elements 150 of consolidated data that identify and characterize the particular customer during the corresponding temporal interval. For instance, consolidated data elements 150 may include, among other things, one or more of the data records of customer profile data 104A, account data 104B, transaction data 104C, credit performance data 106, and/or credit-bureau data 108A associated with the particular customer and ingested by FI computing system 130 on Jun. 30, 2021.

Referring to FIG. 1B, a filtration engine 152 executed by the one or more processors of FI computing system 130 may access each of the data records of consolidated data records 142 maintained within consolidated data store 144 (e.g., data record 142A, as described herein), and perform operations that filter the accessed data records of consolidated data records 142 in accordance with one or more filtration criteria. Executed filtration engine 152 may, for example, determine that a subset of the data records of consolidated data records 142 are consistent with, and in compliance with, the one or more filtration criteria, and may perform operations that stored the filtered subset of the data records within a corresponding portion of consolidated data store 144, e.g., as filtered data records 154.

In some instances, the one or more filtration criteria may include a product-specific filtration criterion that, when processed by executed filtration engine 152, causes executed filtration engine 152 may to exclude, from filtered data records 154, one or more of consolidated data records 142 identifying and characterizing a corresponding customer that fails to hold an issued RESL product during the corresponding temporal interval. As described herein, examples of the issued RESL product may include, but are not limited to, a home mortgage product or a HELOC product. Additionally, or alternatively, the one or more filtration criteria may include a delinquency-specific filtration criterion that, when processed by executed filtration engine 152, causes executed filtration engine 152 to exclude, from filtered data records 154, one or more of consolidated data records 142 identifying and characterizing a corresponding customer of the financial institution that is associated with, or holds, a corresponding RESL product that is closed-off or written-off by the financial institution, or that is associated with a prior or pending delinquency event as of the date of ingestion and consolidation (e.g., Jun. 30, 2021) and further, of inferencing using any of the exemplary processes described herein.

In some examples, the application one or more filtration criteria by executed filtration engine 152 may exclude those customers of the financial institution that fail to represent plausible candidates for early-stage contact and remediation by the financial institution, e.g., prior to the occurrence of a delinquency event involving one or more of the issued RESL products (as these excluded customers are already involved in delinquency event involving one or more of the secured or unsecured credit products described herein). The disclosed embodiments are, however, not limited to these exemplary product- and delinquency-specific filtration criteria, and in other instances, executed filtration engine 152 may apply any additional or alternate filtration criterion to the data records of consolidated data records 142 that would be appropriate to the customers of the financial institution, the financial institution, and consolidated data records 142, and that facilitate an adaptive training and validation of the exemplary machine-learning or artificial intelligence processes described herein.

For example, as illustrated in FIG. 1B, executed filtration engine 152 may access discrete data record 142A of consolidated records 142A, which includes customer identifier 146 of the particular customer (e.g., an alphanumeric character string “CUSTID”), temporal identifier 148 of the corresponding temporal interval (e.g., a numerical string “2021-06-30”), and consolidated data elements 150 that identify and characterize the particular customer during the corresponding temporal interval. In some instances, the particular customer may hold a RESL product issued by the financial institution, such as a home mortgage product or a HELOC product, executed filtration engine 152 may perform operations that parse consolidated data elements 150 and obtain information that identifies a product type associated with the RESL product, e.g., an identifier of the home mortgage product or a HELOC product.

Based on the application of the product-specific filtration criterion described herein to the obtained information, executed filtration engine 152 may confirm that the particular customer holds one of the RESL products issued by the financial institution, and may establish that data record 142A satisfies the product-specific filtration criterion. In response to the established satisfaction of the product-specific filtration criterion, executed filtration engine 152 may perform operations that augment data record 142A to include data, such as product-specific flag 156A, confirming that the particular customer holds one or more of the RESL products issued by the financial institution during the corresponding temporal interval, and as such, that data record 142A satisfies the product-specific filtration criterion, e.g., that the particular customers holds the issued home mortgage or HELOC product.

Further, and in addition to, or as an alternate to, the application of the product-specific filtration criterion to consolidated data records 142, executed filtration engine 152 may perform operations that apply a delinquency-specific filtration criterion to one or more of the data records of consolidated data records 142. For example, executed filtration engine 152 may access discrete data record 142A of consolidated records 142A, and may perform operations that parse consolidated data elements 150 and obtain data indicative of an occurrence (or a non-occurrence) of a delinquency event involving the particular customer and one or more of the RESL products during the temporal interval specified within the temporal interval associated with temporal identifier 148, e.g., between Jun. 1, 2021, and Jun. 30, 2021. By way of example, executed filtration engine 152 may apply the delinquency-specific filtration criterion to the obtained data indicative of the occurrence of the delinquency event, and may determine that the particular customer is involved in a delinquency event associated with the one or more issued RESL products, e.g., the due date of the missed payment falls within the month-long interval extending from Jun. 1, 2021, and Jun. 30, 2021; or (ii) remained pending during at least a portion of the corresponding temporal interval (e.g., the missed payment remains past-due during at least a portion of the month-long interval extending from Jun. 1, 2021, and Jun. 30, 2021).

Based on the determination that the particular customer fails to be involved in a delinquency event associated with the one or more issued RESL products that either occurred or remained pending during the corresponding temporal interval, executed filtration engine 152 may establish that data record 142A satisfies the delinquency-specific filtration criterion. Further, as illustrated in FIG. 1A, executed filtration engine 152 may perform operations that augment data record 142A to include data, such as delinquency-specific flag 156B, confirming that the absence of a delinquency event involving the particular customer and the one or more issued RESL products that either occurred during or extended through the corresponding temporal interval and as such, that data record 142A satisfies the product-specific filtration criterion.

In some examples, and responsive to the determination that data record 142A satisfies the product-specific filtration criterion and additionally, or alternatively, that data record 142A satisfies the delinquency-specific filtration criterion, executed filtration engine 152 may perform operations that store data record 142A (as augmented to include product-specific flag 156A and/or delinquency-specific flag 156B) within an additional portion of consolidated data store 144, e.g., as one or filtered data records 154. As described herein, the determination, by executed filtration engine 152, that data record 142A satisfies the product-specific filtration criterion and/or the delinquency-specific filtration criterion may indicate that data record 142A, and the elements of consolidated data 150 maintained within data record 142A, may be suitable for training adaptively the gradient-boosted, decision-tree process described herein.

Further, although not illustrated in FIG. 1B, executed filtration engine 152 may establish that data record 142A fails to satisfy the product-specific filtration criterion and additionally, or alternatively, the delinquency-specific filtration criteria. For example, in applying the product-specific filtration criterion to data record 142A, executed filtration engine 152 may determine that the particular customer fails to hold a RESL product issued by the financial institution during the corresponding temporal interval and as such, may establish that data record 142A is inconsistent with the product-specific filtration criterion. Additionally, or alternatively, in applying the delinquency-specific filtration criterion to data record 142A, executed filtration engine 152 may determine that the particular customer is involved in a delinquency event involving one or more RESL products that either occurred during or extended through the corresponding temporal interval and as such, may establish that data record 142A is inconsistent with the delinquency-specific filtration criterion. Based on the established inconsistency between data record 142A and the product-specific filtration criterion and/or the delinquency-specific filtration criterion, executed filtration engine 152 may determine that data record 142A is unsuitable for adaptively training and validating the machine-learning or artificial intelligence process described herein, and may decline to store data record 142A within the additional portion of consolidated data store 144 associated with filtered data records 154.

Further, executed filtration engine 152 may access each of the additional data records of consolidated data records 142, and may perform any of the exemplary processes described herein to establish a consistency, or an inconsistency, between each of the additional data records and the product-specific filtration criterion, the delinquency-specific filtration criterion, and any additional, or alternate, filtration criterion. Based on the established consistency with all, or a selected subset, or these filtration criteria, executed filtration engine 152 may perform operations that store corresponding ones of the additional data records within filtered data records 154, e.g., in conjunction with a corresponding flag confirming the established satisfaction of each of the product-specific, delinquency-specific, or other filtration criterion. Alternatively, based on the established in consistency with one or more of these filtration criteria, executed filtration engine 152 may deem the corresponding ones of the additional data records unsuitable for adaptively training and validating the machine-learning or artificial intelligence, and may decline to store these additional data records within the portion of consolidated data store 144 associated with filtered data records 154 (also not illustrated in FIG. 1B).

Referring back to FIG. 1B, an aggregation engine 158 executed by the one or more processors of FI computing system 130 may access each of the data records of filtered data records 154. As described herein, each of the accessed data records may include corresponding elements of consolidated data that identify and characterize a particular customer of the financial institution during a corresponding temporal interval (e.g., the data records of customer profile data 104A, account data 104B, transaction data 104C, credit performance data 106, and/or credit-bureau data 108A associated with the particular customer and ingested by FI computing system 130). Further, and for each of the accessed data records, executed aggregation engine 158 may perform operations that process the corresponding elements of consolidated data and generate elements of aggregated account data that characterize a usage of one or more financial products or instruments during the corresponding temporal interval, and elements of aggregated transaction data characterizing a spending, payment, or other transactional habit of the particular customer during the corresponding temporal interval.

By way of example, executed aggregation engine 158 may access data record 142A within filtered data records 154, which includes consolidated data elements 150 that identifies and characterizes a particular customer of the financial institution (e.g., associated with customer identifier 146) during a corresponding temporal interval (e.g., the one-month interval between Jun. 1, 2021, and Jun. 30, 2021, as specified by temporal identifier 148). Executed aggregation engine 158 may also perform operations that obtain, from consolidated data elements 150, elements of account data that identify and characterize the interactions between the particular customer and the one or more financial products or instruments issued by the financial institution during the corresponding temporal interval (e.g., one or more data records of account data 104B ingested by FI computing system 130), and elements of transaction data that identify and characterize one or more transactions initiated by the particular customer during the corresponding temporal interval (e.g., one or more data records of transaction data 104C ingested by FI computing system 130).

In some instances, executed aggregation engine 158 may perform operations that generate one or more elements of aggregated account data 160 based on corresponding portions of the obtained account data elements, and that generate one or more elements of aggregated transaction data 162 based on corresponding portions of the obtained transaction data elements. For example, the elements of aggregated account data 160 may include, but are not limited to, an average of a total balance across one or more unsecured credit products held by the customer associated with customer identifier 146 during the temporal interval associated with temporal identifier 148 (e.g., an average balance across a credit-card account, a line-of-credit, a personal loan, etc.), an average of a total amount of credit extended to the customer by the financial institution during the temporal interval, or an average balance of funds available to the customer within one or more demand deposit accounts during the corresponding temporal interval. In some examples, the elements of aggregated transaction data 162 may include, but are not limited to, a total transaction amount attributable to one or more types of transactions initiated by the customer during the temporal interval, such as, but not limited to, purchase transactions, peer-to-peer transactions, payroll deposits, bill-payment transactions, real-time payment transactions, or electronic funds transfers (EFT) transactions.

Further, and by way of example, the elements of aggregated transaction data 162 may include values of aggregated transaction parameters that characterize a particular type or class of transaction, such as purchase transactions initiated by the customer associated with customer identifier 146 during the temporal interval associated with temporal identifier 148. For instance, the elements of aggregated transaction data 162 may include, among other things, a total transaction amount attributable to the initiated purchase transactions involving certain categories of merchants (e.g., based on corresponding SIC codes or MCCs maintained with the obtained transaction data elements, etc.), a total transaction amount attributable to the initiated purchase transactions involving certain purchased products or services, or a total transaction amount attributable to the initiated purchase transactions involving certain processing networks, such as, but not limited to, conventional payment rails or real-time payment rails. The disclosed embodiments are, however, not limited to these exemplary elements of aggregated account or transaction data, and in other instances, executed aggregation engine 158 may process filtered data records 154 and generate any additional, or alternate, elements of aggregated account data 160 that characterize the usage of the financial products or instruments held by the particular customer during the temporal interval, and any additional, or alternate, elements of aggregated transaction data 162 characterizing a spending or purchasing habit of the customer during the temporal interval.

In some instances, executed aggregation engine 158 may perform operations that augment the accessed data record 142A (e.g., as maintained within a portion of consolidated data store 144 associated with filtered data records 154) to include the elements of aggregated account data 160 and the elements of aggregated transaction data 162. Further, although not illustrated in FIG. 1B, executed aggregation engine 158 may also perform any of the exemplary processes described herein to access each additional, or alternate, data record of filtered data records 154, to generate one or more elements of aggregated account and transaction data associated with a corresponding one of the customers during a corresponding temporal interval, and to augment each of the additional, or alternate, data records to include respective ones of the generate elements of aggregated account and transaction data.

Further, as illustrated in FIG. 1B consolidated data store 144 may maintain each of filtered data records 154 in conjunction with additional filtered data records 164. In some instances, executed pre-processing engine 140, executed filtration engine 152, and executed aggregation engine 158 may perform any of the exemplary processes described herein, either individually or collectively, to generate each of the additional filtered data records 164 based on elements of profile, account, transaction, insolvency, and credit-bureau data ingested from source systems 102 during the corresponding prior temporal intervals.

In some instances, each of additional filtered data records 164 may include a plurality of discrete data records that are associated with and characterize a particular one of the customers of the financial institution during a corresponding one of the prior temporal intervals. For example, additional filtered data records 164 may include one or more discrete data records, such as discrete data record 165, associated with a prior temporal interval extending from Apr. 1, 2021, to Apr. 30, 2021. For the particular customer, discrete data record 165 may include a customer identifier 166 of the particular customer (e.g., an alphanumeric character string “CUSTID”), a temporal identifier 167 of the prior temporal interval (e.g., a numerical string “2021-04-30”), and consolidated elements 168 of customer profile, account, transaction, insolvency, or credit-bureau data that characterize the particular customer during the prior temporal interval extending from Apr. 1, 2021, to Apr. 30, 2021 (e.g., as consolidated from the data records ingested by FI computing system 130 on Apr. 30, 2021).

As illustrated in FIG. 1B, discrete data record 165 may also include one or more data flags indicative of an established consistency of discrete data record 165 with one or more filtration criteria, such as, but not limited to, a product-specific flag 169A indicative of an established consistency between data record 165 and the product-specific filtering criterion described herein, and a delinquency-specific flag 169B indicative of an established consistency between data record 165 and the delinquency-specific filtering criterion described herein. Further, discrete data record 165 may include one or more elements of aggregated account data 170 that characterize the usage of the financial products or instruments held by the particular customer during the prior temporal interval, and one or more elements of aggregated transaction data 171 characterizing a spending or purchasing habit of the particular customer during the prior temporal interval. In some instances, each of the additional, or alternate, data records of filtered data records 164 may include and maintain a customer identifier, temporal identifier, consolidated data elements, data flags, and elements of aggregated account or transaction data, which may be similar in structure and composition to those described above in reference to data record 165.

The disclosed embodiments are, however, not limited to the exemplary consolidated or filtered data records described herein, or to the exemplary temporal intervals described herein. In other examples, FI computing system 130 may generate, and the consolidated data store 144 may maintain, any additional or alternate number of discrete sets of filtered data records, having any additional or alternate composition, that would be appropriate to the elements of customer profile, account, transaction, credit performance, or credit-bureau data ingested by FI computing system 130 at the predetermined intervals described herein. Further, in some examples, FI computing system 130 may ingest elements of customer profile, account, transaction, credit performance, or credit-bureau data from source systems 102 at any additional, or alternate, fixed or variable temporal interval that would be appropriate to the ingested data.

In some instances, FI computing system 130 may perform any of the exemplary operations described herein to adaptively train, using training datasets associated with a first prior temporal interval (e.g., a “training” interval), and using validation datasets associated with a second, and distinct, prior temporal interval (e.g., an out-of-time “validation” interval), a machine-learning or artificial-intelligence process to predict a likelihood of (i) a non-occurrence of a delinquency event involving a customer of the financial institution and an issued RESL product during a first portion of a target temporal interval and (ii) an occurrence of a default event involving the customer of the financial institution and the issued RESL product during a second portion of a target temporal interval. By way of example, a delinquency event involving the customer of the financial institution and the issued RESL product occurs during the first or second portions of the target temporal interval when the customer fails to submit a scheduled payment associated with issued RESL product (e.g., when that scheduled payment becomes “past due”).

Further, and as described herein, a default event occurs during the second portion of the target temporal interval when, during the second portion of the target temporal interval, the customer fails to submit a scheduled payment associated with issued RESL product and the scheduled payment remains past due for a predetermined temporal interval. For example, and as described herein, the target temporal interval may include twelve months, the first portion may include an initial, three-month portion of the twelve-month target temporal interval, and the second portion may include a subsequent, nine-month portion of the twelve-month target temporal interval. Further, the predetermined temporal interval associated with the past-due payment (e.g., a corresponding past-due period) may include, but is not limited to, ninety calendar days. In some instances, through a prediction of a likelihood that a particular customer of the financial institution will be associated with a non-occurrence of a delinquency event involving an issued RESL product during a future three-month interval, but will be associated with an occurrence of a default event involving that issued RESL product during a subsequent, nine-month interval, certain of the exemplary processes described herein may enable a computing system of the financial institution, such as RESL computing system 110, to establish that particular customer, and the issued RESL product, are at risk of early-stage delinquency, and that the particular customer represents a candidate for one or more remediation or treatment processes, which may mitigate the risk of the early-stage delinquency or reduce an exposure of the financial institution to the early-stage delinquency.

In some examples, the machine-learning or artificial-intelligence process may include an ensemble or decision-tree process, such as a gradient-boosted decision-tree process (e.g., the XGBoost model), and the training and validation datasets may include, but are not limited to, values of adaptively selected features obtained, extracted, or derived from the filtered data records maintained within consolidated data store 144, e.g., from data elements maintained within the discrete data records of filtered data records 154 or the additional filtered data records 164. As described herein, each of the discrete data records may include additional elements of consolidated data, aggregate account data, and/or aggregate transaction data that identify and characterize the corresponding customer, and the interactions between the corresponding customer and the financial institution.

Further, and by way of example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within consolidated data store 144.

Referring to FIG. 1C, a training engine 172 executed by the one or more processors of FI computing system 130 may access the filtered data records maintained within consolidated data store 144, such as, but not limited to, filtered data records 154 or additional filtered data records 164. As described herein, each of the filtered data records, such as discrete data record 142A of filtered data records 154 or discrete data record 165 of additional filtered data records 164, may include a customer identifier of a corresponding one of the customers of the financial institution (e.g., customer identifiers 146 and 166 of FIG. 1B) and a temporal identifier that associates the filtered data record with a corresponding temporal interval (e.g., temporal identifiers 148 and 167 of FIG. 1B). Further, as described herein, each of the filtered data records may include consolidated elements of customer profile, account, transaction, credit performance, or credit-bureau data that characterize the corresponding one of the customers during the corresponding temporal interval (e.g., consolidated data elements 150 and 168 of FIG. 1B), elements of aggregated account data that characterize interactions between the corresponding one of the customers and issued financial products or instruments during the corresponding temporal interval (e.g., aggregated account data elements 160 and 170 of FIG. 1B), and elements of aggregated transaction data characterizing a purchasing or spending behavior of the corresponding one of the customers during the corresponding temporal interval (e.g., aggregated transaction data elements 162 and 171 of FIG. 1B). Each of the filtered data records may also satisfy one or more filtration criteria, such as, but not limited to, the product- and delinquency-specific filtration criteria described herein, and may also include a data flag indicative of the consistency with corresponding ones of the product- and delinquency-specific filtration criteria described herein (e.g., product-specific flags 156A and 169A, delinquency-specific flags 156B, and 169B of FIG. 1B, etc.).

In some instances, executed training engine 172 may parse the filtered data records and, based on corresponding ones of the temporal identifiers, determine that the consolidated elements of customer profile, account, transaction, delinquency, or credit-bureau data characterize the corresponding customers across a range of prior temporal intervals. Further, executed training engine 172 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1D, the range of prior temporal intervals (e.g., shown generally as At along timeline 173 of FIG. 1D) may be bounded by, and established by, temporal boundaries tᵢ and t_{f}. Further, the decomposed first subset of the prior temporal intervals (e.g., shown generally as training interval Δt_{training} along timeline 173 of FIG. 1D) may be bounded by temporal boundary tᵢ and a corresponding splitting point tₛₚₗᵢₜ along timeline 173, and the decomposed second subset of the prior temporal intervals (e.g., shown generally as validation interval Δt_{validation} along timeline 173 of FIG. 1D) may be bounded by splitting point tₛₚₗᵢₜ and temporal boundary t_{f}.

Referring back to FIG. 1C, executed training engine 172 may generate elements of splitting data 174 that identify and characterize the determined temporal boundaries (e.g., temporal boundaries tᵢ and t_{f}) and the range of prior temporal intervals established by the determined temporal boundaries The elements of splitting data 174 may also identify and characterize the splitting point (e.g., the splitting point tₛₚₗᵢₜ described herein), the first subset of the prior temporal intervals (e.g., the training interval Δt_{training} described herein), and the second, and subsequent subset of the prior temporal intervals (e.g., the validation interval Δt_{validation} described herein). As illustrated in FIG. 1C, executed training engine 172 may store the elements of splitting data 174 within the one or more tangible, non-transitory memories of FI computing system 130, e.g., within consolidated data store 144.

In some instances, each of the prior temporal intervals may correspond to a one-month interval, and executed training engine 172 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. By way of example, executed training engine 172 may compute one or both of the first and second predetermined percentages, and establish the splitting point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

As illustrated in FIG. 1C, a training input module 176 of executed training engine 172 may perform operations that access the filtered data records maintained within consolidated data store 144. As described herein, each of the accessed data records (e.g., the discrete data records within filtered data records 154 or additional filtered data records 164) may identify and characterize a customer of the financial institution (e.g., identified by a corresponding customer identifier) during a temporal interval (e.g., associated with a corresponding temporal identifier) and interactions of the customer with the financial institution, with other financial institutions, and with financial products or instruments issued by these financial institutions (e.g., the exemplary RESL products described herein) during the temporal interval. Based on portions of splitting data 174, executed training input module 176 may perform operations that parse the filtered data records (e.g., the discrete data records within filtered data records 154 or additional filtered data records 164) and determine: (i) a first subset 178A of these consolidated data records are associated with the training interval Δt_{training} and may be appropriate to training adaptively the gradient-boosted decision model during the training interval; and a (ii) second subset 178B of these consolidated data records are associated with the validation interval Δt_{validation} and may be appropriate to validating the adaptively trained gradient-boosted decision model during the validation interval.

In some instances, and prior to partitioning the filtered data records into corresponding ones of the first subset 178A and second subset 178B, executed training input module 176 may perform operations that partition the filtered data records maintained within consolidated data store 144 (e.g., the discrete data records within filtered data records 154 or additional filtered data records 164) into customer-specific subsets of filtered data records based on the customer identifier maintained within each of the filtered data records (e.g., customer identifier 146 of filtered data record 142A, customer identifier 166 of filtered data record 165, etc.), and that sequentially order the filtered data records within each of the customer-specific subsets in accordance with the temporal identifies maintained within each of the filtered data records (e.g., temporal identifier 148 of filtered data record 142A, temporal identifier 167 of filtered data record 165, etc.). Further, executed training input module 176 may also perform operations that augment one or more of the filtered data records (e.g., filtered data records 154 and 164, etc.) to include additional information characterizing a ground truth associated with the corresponding customer and temporal interval (as established by the corresponding pair of customer and temporal identifiers).

The information characterizing the ground truth for a particular one of the filtered data records may, for example, specify whether the customer associated with the corresponding customer identifier is associated with both (i) a non-occurrence of a delinquency event involving an issued RESL product during a three-month period subsequent to the temporal interval specified within the corresponding temporal identifier (e.g., the first portion of the target temporal interval described herein) and (ii) an occurrence of a default event involving the issued RESL product during a nine-month period disposed between four and twelve months subsequent to the temporal interval (e.g., the second portion of the target temporal interval described herein). In some instances, to generate the information characterizing the ground truth for the particular filtered data record, executed training input module 176 may obtain a customer identifier and a temporal from the particular filtered data record, and may access one of more data records of consolidated data records 142 that include, or reference, the obtained customer identifier.

As described herein, the obtained customer identifier may be associated with a particular customer of the financial institution, the obtained temporal identifier may be associated with a particular temporal identifier, an further, each of the accessed data records of consolidated data records 142 may include elements of consolidated data (e.g., consolidated data elements 150 of data record 142A) characterizing a credit performance of the particular customer during a temporal interval disposed prior to, or subsequent to, the particular temporal interval. In some examples, executed training input module 176 parse the elements of consolidated data within the accessed data records to establish whether the particular customer is associated with a delinquency event involving an issued RESL product (e.g., a missed payment, a payment inconsistent with a repayment request, etc.) during a three-month period subsequent to the particular temporal interval. If executed training input module 176 were to establish that the particular customer were associated with an occurrence of a delinquency event involving the issued RESL product during the initial, three-month period, executed training input module 176 may establish that the particular one of the filtered data records represents a “negative” target (e.g., that the particular customer, and the issued RESL product, are not at risk of early-stage delinquency), and may generate data characterizing the negative target (e.g., a value of zero, elements of textual content, such as “N,” etc.).

Alternatively, if executed training input module 176 were to establish that the particular customer were associated with a non-occurrence of the delinquency event involving the issued RESL product during the initial, three-month period, executed training input module 176 may perform further operations that establish whether the particular customer is associated with an occurrence of a default event involving the issued RESL product during the nine-month period, e.g., whether the customer is associated with an occurrence of a delinquency event involving the issued RESL product, and that a pendency of the delinquency event extends to ninety days, during the nine-month period. For example, if executed training input module 176 were to establish that the particular customer were associated with non-occurrence of the default event involving the issued RESL product during the nine-month period (e.g., that the issued RESL product fails to become delinquent during the nine-month period, or that the pendency of the delinquency event fails to extend to ninety days), executed training input module 176 may establish that the particular one of the filtered data records represents a “negative” target, and may generate data characterizing the negative target, as described herein. In other examples, if executed training input module 176 were to establish that the particular customer were associated with the occurrence of the default event involving the issued RESL product during the nine-month period, executed training input module 176 may establish that the particular one of the filtered data records represents a “positive” target (e.g., that the particular customer, and the issued RESL product, are at risk of early-stage delinquency), and may generate data characterizing the positive target (e.g., a value of unity, additional elements of textual content, such as “Y,” etc.).

In some instances, executed training input module 176 may package the data characterizing the positive or negative target into a portion of the ground-truth information for the particular one of the filtered data records, and may augment the particular one of the filtered data records (e.g., as maintained within consolidated data store 144) to include the ground-truth information. Further, executed training input module 176 may also perform any of the exemplary processes described herein to generate a corresponding element of ground-truth information for all, or a selected subset, of the additional or alternate filtered data records maintained within consolidated data store 144, and to augment each, or the selected subset, of the additional or alternate filtered data records to include the corresponding element of ground-truth information.

Referring back to FIG. 1C, executed training input module 176 may perform any of the exemplary processes described herein to partition the filtered data records maintained within consolidated data store 144 into subsets suitable for training adaptively the gradient-boosted, decision-tree process (e.g., which may be maintained in first subset 178A of filtered data records within consolidated data store 144) and for validating the adaptively trained, gradient-boosted, decision-tree process (e.g., which may be maintained in second subset 178B of filtered data records within consolidated data store 144). By way of example, executed training input module 176 may access splitting data 174, and establish the temporal boundaries for the training interval Δt_{training} (e.g., temporal boundary tᵢ and splitting point tₛₚₗᵢₜ) and the validation interval Δt_{training} (e.g., splitting point twit and temporal boundary t_{f}). In some instances, executed training input module 176 may parse each of the filtered data records within consolidated data store 144 (e.g., as maintained within the sequentially ordered, customer-specific subsets described herein), access the corresponding temporal identifier, and determine the temporal interval associated with the each of the filtered data records.

If, for example, executed training input module 176 were to determine that the temporal interval associated with a corresponding one of the filtered data records is disposed within the temporal boundaries for the training interval Δt_{training}, executed training input module 176 may determine that the corresponding data record may be suitable for training, and may perform operations that include the corresponding data record within a portion of the first subset 178A (e.g., that store the corresponding data record within a portion of consolidated data store 144 associated with first subset 178A). Alternatively, if executed training input module 176 were to determine that the temporal interval associated with a corresponding one of the filtered data records is disposed within the temporal boundaries for the validation interval Δt_{validation}, executed training input module 176 may determine that the corresponding data record may be suitable for validation, and may perform operations that include the corresponding data record within a portion of the second subset 178B (e.g., that store the corresponding data record within a portion of consolidated data store 144 associated with second subset 178B). Executed training input module 176 may perform any of the exemplary processes described herein to determine the suitability of each additional, or alternate, one of the sequentially ordered data records of the customer-specific sets for adaptive training, or alternatively, validation, of the gradient-boosted, decision-tree process.

Referring back to FIG. 1C, executed training input module 176 may perform operations that generate a plurality of training datasets 180 based on elements of data obtained, extracted, or derived from all or a selected portion of first subset 178A of the consolidated data records. By way of example, each of the plurality of training datasets 180 may be associated with a corresponding one of the customers of the financial institution and a corresponding temporal interval, and may include, among other things a customer identifier associated with that corresponding customer and a temporal identifier representative of the corresponding temporal interval within the training interval Attaining, as described herein. In some instances, each of the plurality of training datasets 180 may also include elements of data (e.g., feature values) that characterize the corresponding one of the customers and the corresponding customer's interaction with the financial institution, with other financial institution, and with financial products and instruments issued by the financial institution, such as, but not limited to the RESL account described herein. Further, each of training datasets 180 may also include an element of ground-truth information indicative of whether the corresponding one of the filtered data records represents a positive or negative target (e.g., whether, or not, the customer associated with the corresponding customer identifier is associated with both (i) a non-occurrence of a delinquency event involving an issued RESL product during a three-month period subsequent to the temporal interval specified within the corresponding temporal identifier and (ii) an occurrence of a default event involving the issued RESL product during a nine-month period disposed between four and twelve months subsequent to the temporal interval, as described herein).

In some instances, executed training input module 176 may perform operations that identify, and obtain or extract, one or more of the features values from the filtered data records maintained within first subset 178A and associated with the corresponding one of the customers. For example, the obtained or extracted feature values may include elements of the customer profile, account, transaction, credit performance, or credit-bureau data described herein, along with elements of aggregated account or transaction data, which may populate collectively the filtered data records maintained within first subset 178A. Examples of these obtained or extracted feature values may include, but are not limited to: data identifying one or more types of financial products held by the corresponding ones of the customers, e.g., such as one or more of the RESL products described herein; time-averaged balances of one or more credit products held by the corresponding ones of the customers, and time-averaged sums of these balances; time-averaged balances of one or more deposit accounts held by the corresponding ones of the customers, and time-averaged sums of these balances; time-average values of purchase transactions initiated by corresponding ones of the customers on across one or more merchant or retailer categories, or that involve one or more types of products or services; a number of credit inquiries involving the corresponding one of the customers; or an occurrence or non-occurrence of a personal bankruptcy involving corresponding ones of the customers. The disclosed embodiments are, however, not limited to these obtained or extracted feature values, and in other instances, training datasets 180 may include any additional or alternate element of data extracted or obtained from the filtered data records of first subset 178A and associated with corresponding one of the customers.

Further, in some instances, executed training input module 176 may perform operations that compute, determine, or derive one or more of the features values based on elements of data extracted or obtained from the filtered data records maintained within first subset 178A. Examples of these computed, determined, or derived feature values may include, but are not limited to: a computed temporal interval during which corresponding ones of the customers reside at a current mailing address; aggregated values characterizing relationships between the financial institution and corresponding ones of the customers; a total number of secured or unsecured credit products held by corresponding ones of the customers; or total numbers of past-due balances or delinquencies associated with corresponding ones of the customers in various secured or unsecured credit products. The disclosed embodiments are, however, not limited to these computed, determined, or derived feature values, and in other instances, training datasets 180 may include any additional or alternate features computed, determine, or derived from data extracted or obtained from the filtered data records of first subset 178A associated with corresponding one of the customers.

Executed training input module 176 may provide training datasets 180 as an input to an adaptive training and validation module 182 of executed training engine 172. In some instances, and upon execution by the one or more processors of FI computing system 130, adaptive training and validation module 182 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets 180. Based on the execution of adaptive training and validation module 182, and on the ingestion of each of training datasets 180 by the established nodes of the gradient-boosted, decision-tree process, FI computing system 130 may perform operations that adaptively train the gradient-boosted, decision-tree process against the elements of training data included within each of training datasets 180.

In some examples, the distributed components of FI computing system 130 may execute adaptive training and validation module 182, and may perform any of the exemplary processes described herein in parallel to train adaptively the gradient-boosted, decision-tree process against the elements of training data included within each of training datasets 180. The parallel implementation of adaptive training and validation module 182 by the distributed components of FI computing system 130 may, in some instances, be based on an implementation, across the distributed components, of the parallelized, fault-tolerant distributed computing and analytical protocols described herein (e.g., the Apache Spark™ distributed, cluster-computing framework, etc.).

By way of example, and referring to FIG. 1E, executed adaptive training and validation module 182 may perform operations that train adaptively a machine-learning or artificial-intelligence process (e.g., the gradient-boosted, decision-tree process described herein) to predict, at a temporal prediction point t_{pred} along timeline 179, a likelihood of both (i) a non-occurrence of a delinquency event involving a customer of the financial institution and an issued RESL product during a first portion Δt_{clean} of a future target temporal interval Δt_{target} and (ii) an occurrence of a default event involving the customer and the issued RESL product during a second portion Δt_{delinquency} of target temporal interval Δt_{target}. As described herein, a delinquency event involving the customer and the issued RESL product (e.g., home mortgage product, a HELOC product, etc.) may occur when that customer fails to submit a scheduled payment associated with the issued RESL product to the financial institution. Further, and as described herein, a default event may occur during second portion Δt_{delinquency} of target temporal interval Δt_{target} when, during second portion Δt_{delinquency}, the customer fails to submit a scheduled payment associated with issued RESL product and the scheduled payment remains past due for at least a predetermined, threshold temporal interval.

For instance, as illustrated in FIG. 1F, the customer may miss the scheduled payment associated with issued RESL product at a particular temporal initiation point tᵢₙᵢₜ along timeline 179, which may be disposed within second portion Δt_{delinquency} of target temporal interval Δt_{target}. The missed payment may, in some instances correspond to a delinquency event involving the customer and the issued RESL product (e.g., occurring at temporal initiation point tᵢₙᵢₜ), and the corresponding delinquency event, and the missed payment, may be associated with a past-due interval within second portion Δt_{delinquency} of target temporal interval Δt_{target}, illustrated as Δt_{past-due} in FIG. 1F. In some examples, the default event involving the customer and issued RESL product may occur within second portion Δt_{delinquency} when past-due interval Δt_{past-due} exceeds the predetermined, threshold temporal interval during second portion Δt_{delinquency}.

By way of example, the target temporal interval Δt_{target} may be characterized by a predetermined duration, such as, but not limited to, twelve months, and the prior extraction interval Δt_{extract} may be characterized by a corresponding, predetermined duration, such as, but not limited to, one month. Further, the future target temporal interval Δt_{target} may include a twelve-month interval, first portion Δt_{clean} may include an initial, three-month portion of the twelve-month interval (e.g., disposed between one and three months of temporal prediction point tₚred), and second portion Δt_{delinquency} may include a subsequent, nine-month period of the twelve-month interval (e.g., disposed between four and twelve months of temporal prediction point t_{pred}). Additionally, in some examples, the predetermined, threshold interval may include, but is not limited to, ninety calendar days. Through a prediction of a likelihood that a customer of the financial institution will be associated with a non-occurrence of a delinquency event involving an issued RESL product during a future three-month interval, and will be associated with an occurrence of a default event involving that issued RESL product during a subsequent, nine-month interval, certain of the exemplary processes described herein may enable a computing system of the financial institution, such as RESL computing system 110, to establish that the customer, and the issued RESL product, are at risk of early-stage delinquency, and that the customer represents a candidate for one or more remediation processes that mitigate the risk of the early-stage delinquency or reduce an exposure of the financial institution to the early-stage delinquency.

Referring back to FIG. 1C, and through the performance of these adaptive training processes, executed adaptive training and validation module 182 may perform operations that compute one or more candidate model parameters that characterize the adaptively trained, gradient-boosted, decision-tree process, and package the candidate model parameters into corresponding portions of candidate model data 184. Further, and based on the performance of these adaptive training processes, executed adaptive training and validation module 182 may also generate candidate input data 186, which specifies a candidate composition of an input dataset for the adaptively trained, gradient-boosted, decision-tree process (e.g., which be provisioned as inputs to the nodes of the decision trees of the adaptively trained, gradient-boosted, decision-tree process). In some instances, the candidate model parameters included within candidate model data 184 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

As illustrated in FIG. 1C, executed adaptive training and validation module 182 may provide candidate model data 184 and candidate input data 186 as inputs to executed training input module 176 of training engine 172, which may perform any of them exemplary processes described herein to generate a plurality of validation datasets 188 having compositions consistent with candidate input data 186. As described herein, the plurality of validation datasets 188 may, when provisioned to, and ingested by, the nodes of the decision trees of the adaptively trained, gradient-boosted, decision-tree process, enable executed training engine 172 to validate the predictive capability and accuracy of the adaptively trained, gradient-boosted, decision-tree process, for example, based on elements of ground truth data incorporated within the validation datasets 188, or based on one or more computed metrics, such as, but not limited to, computed precision values, computed recall values, and computed area under curve (AUC) for receiver operating characteristic (ROC) curves or precision-recall (PR) curves.

By way of example, each of the plurality of validation datasets 188 may be associated with a corresponding one of the customers of the financial institution and a corresponding temporal interval, and may include, among other things a customer identifier associated with that corresponding customer and a temporal identifier representative of the corresponding temporal interval, as described herein within the validation interval Δt_{validation}. Further, and for each of the plurality of validation datasets 188, the corresponding customer may hold a RESL product issued by the financial institution.

In some instances, executed training input module 176 may parse candidate input data 186 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 176 and packaged into corresponding potions of training datasets 180, as described herein.

For example, executed training input module 176 may access the filtered data records maintained within second subset 1786, and based on portions of candidate input data 186, may perform any of the exemplary processes described herein to obtain or extract, or to compute, determine, or derive, the customer-specific feature values of the validation datasets. Executed training input module 176 may package each of the customer-specific feature values (e.g., as obtained, extracted, computed, determined, or derived from the filtered data records within second subset 178B) into corresponding positions within customer-specific ones of validation datasets 188, e.g., in accordance with the candidate sequence or position specified within candidate input data 186. Further, executed training input module 176 may perform any of the exemplary processes described herein to package a corresponding elements of ground-truth information into an appropriate position within one or more of validation datasets 188.

In some instances, executed training input module 176 may perform any of the exemplary processes described herein to generate a corresponding one of validation datasets 188 associated with each combination of customer and temporal identifier maintained within the filtered data records of second subset 178B. Although in other instances, executed training input module 176 may perform any of the exemplary processes described herein to generate a predetermined number of discrete validation datasets specified within candidate input data 186, or discrete validation data sets consistent with candidate input data 186 and associated with a predetermined set of customers.

Referring back to FIG. 1C, executed training input module 176 may provide the plurality of validation datasets 188 as inputs to executed adaptive training and validation module 182. In some examples, executed adaptive training and validation module 182 may perform operations that apply the adaptively trained, gradient-boosted, decision-tree process to respective ones of validation datasets 188 (e.g., based on the candidate model parameters within candidate model data 184, as described herein), and that generate elements of output data based on the application of the adaptively trained, gradient-boosted, decision-tree process to the respective ones of validation datasets 188.

As described herein, each of the elements of output data may be generated through the application of the adaptively trained, gradient-boosted, decision-tree process to a corresponding one of validation datasets 188, which includes, among other things, a customer identifier (e.g., identifying a corresponding customer of the financial institution), a temporal identifier (e.g., identifying a corresponding temporal interval), and in some instances, an element of ground-truth data. Further, as described herein, each of elements of output data may be representative of a predicted likelihood, at a corresponding temporal prediction point t_{pred}, of an occurrence of both (i) a non-occurrence of a delinquency event involving the corresponding customer of the financial institution and a corresponding, issued RESL product during a first portion Δt_{clean} of a future target temporal interval Δt_{target} and (ii) an occurrence of a default event involving the corresponding customer the issued RESL product during a second portion Δt_{delinquency} of target temporal interval Δt_{target}. In some instances, the predicted likelihood may be represented by, and each of elements of output data may include, a numerical score ranging from zero (e.g., indicative of a minimal predicted likelihood) to unity (e.g., indicative of a maximum predicted likelihood).

Executed adaptive training and validation module 182 may perform operations that compute a value of one or more metrics that characterize a predictive capability, and an accuracy, of the adaptively trained, gradient-boosted, decision-tree process based on the generated elements of output data and corresponding ones of validation datasets 188. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process (e.g., “precision@1,” “precision@5,” “precision@10,” etc.). Further, in some examples, the computed metrics may include a computed value of an area under curve (AUC) for a precision-recall (PR) curve associated with the adaptively trained, gradient-boosted, decision-tree process, and additional, or alternatively, computed value of an AUC for a receiver operating characteristic (ROC) curve associated with the adaptively trained, gradient-boosted, decision-tree process. The disclosed embodiments are, however, not limited to these exemplary computed metric values, and in other instances, executed adaptive training and validation module 182 may compute a value of any additional, or alternate, metric appropriate to validation datasets 188, the elements of ground-truth data, or the adaptively trained, gradient-boosted, decision-tree process

In some examples, executed adaptive training and validation module 182 may also perform operations that determine whether all, or a selected portion of, the computed metric values satisfy one or more threshold conditions for a deployment of the adaptively trained, gradient-boosted, decision-tree process and a real-time application to elements of customer profile, account, transaction, delinquency, or credit-bureau data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values. In some examples, executed adaptive training and validation module 182 that establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, executed adaptive training and validation module 182 were to establish that one, or more, of the computed metric values fail to satisfy at least one of the threshold requirements, FI computing system 130 may establish that the adaptively trained, gradient-boosted, decision-tree process is insufficiently accurate for deployment and application to the elements of customer profile, account, transaction, delinquency, or credit-bureau data described herein. Executed adaptive training and validation module 182 may perform operations (not illustrated in FIG. 1C) that transmit data indicative of the established inaccuracy to executed training input module 176, which may perform any of the exemplary processes described herein to generate one or more additional training datasets and to provision those additional encrypted training datasets to executed adaptive training and validation module 182. In some instances, executed adaptive training and validation module 182 may receive the additional training datasets, and may perform any of the exemplary processes described herein to train further the gradient-boosted, decision-tree process against the elements of training data included within each of the additional training datasets.

Alternatively, if executed adaptive training and validation module 182 were to establish that each computed metric value satisfies threshold requirements, FI computing system 130 may deem the gradient-boosted, decision-tree process adaptively trained, and ready for deployment and application to the elements of customer profile, account, transaction, delinquency, or credit-bureau data described herein. In some instances, executed adaptive training and validation module 182 may generate model data 190 that includes the model parameters of the adaptively trained, gradient-boosted, decision-tree process, such as, but not limited to, each of the candidate model parameters specified within candidate model data 184. Further, executed adaptive training and validation module 182 may also generate input data 192, which characterizes a composition of an input dataset for the adaptively trained, gradient-boosted, decision-tree process and identifies each of the discrete data elements within the input data set, along with a sequence or position of these elements within the input data set (e.g., as specified within candidate input data 186). As illustrated in FIG. 1C, executed adaptive training and validation module 182 may perform operations that store model data 190 and input data 192 within the one or more tangible, non-transitory memories of FI computing system 130, such as consolidated data store 144.

Additionally, in some examples, and based on a determination that the computed metric values satisfy the threshold requirements, a tuning module 183 of executed adaptive training and validation module 182 may perform additional operations that further tune one or more of the candidate model parameters, such as, but not limited to, one or more of the hyperparameters described herein. For example, executed tuning module 183 may establish a range of values, and plurality of discrete parameter values within the range, for each of the one or more candidate model parameters, including the one or more hyperparameters described herein, and may perform operations (e.g., based on a grid search) that train the gradient-boosted decision tree model to convergence using one or more of training datasets 180 or validation datasets 188 in conjunction with randomly selected combinations of the discrete parameter values of the one or more candidate model parameters, including the one or more hyperparameters. Executed tuning module 183 may establish, as the optimal set of the discrete parameter values, the randomly selected combination of discrete parameter values that result in a maximum value of one or more of the computed metrics described herein, such as, but not limited to, the computed area under curve (AUC) for receiver operating characteristic (ROC) curves or precision-recall (PR) curves. In some instances, the optimal set of the discrete parameter values, which executed tuning module 183 may store within portions of model data 190 in consolidated data store 144, may provide a maximum performance when applied to validation datasets 188 without overfitting training datasets 180.

In some examples, the elements of training datasets 180 and validation datasets 188 may characterize an interaction between customers of the financial institution and corresponding ones of a plurality of RESL products issued by the financial institution (such as the home mortgage products or HELOC products described herein), may identify and characterize patterns in payment transactions involving these issued RESL products, and further, may identify delinquency events involving these customers and the issued RESL products during corresponding temporal intervals. By leveraging training datasets 180 and validation datasets 188 associated with multiple types of RESL products issued by the financial institution, the resulting, adaptively trained and validated gradient-boosted, decision-tree process may be capable of predicting the likelihood of occurrences of default events involving not a single RESL product, but instead, any of a variety of different RESL products held by corresponding customers of the financial institution, such as, but not limited to, the various types of home mortgage products or HELOC products described herein.

B. Exemplary Processes for Predicting Future Events of Predetermined Duration using Adaptively Trained, Machine-Learning or Artificial-Intelligence Processes

In some examples, one or more computing systems associated with or operated by a financial institution, such as one or more of the distributed components of FI computing system 130, may perform operations that adaptively train a machine-learning or artificial-intelligence process to predict a likelihood of both (i) a non-occurrence of a delinquency event involving a customer of the financial institution and an issued RESL product during a first portion of a target temporal interval and (ii) an occurrence of a default event involving the customer and the issued RESL product during a second portion of the target temporal interval. For instance, and as described herein, a delinquency event involving the customer and the issued RESL product may occur when the customer fails to submit a scheduled payment associated with issued RESL product (e.g., when that scheduled payment becomes “past due”). Further, a default event may occur during the second portion of the target temporal interval when, during the second portion of the target temporal interval, the customer fails to submit a scheduled payment associated with issued RESL product and the scheduled payment remains past due for at least a predetermined threshold interval. In some examples, the target temporal interval may include twelve months, the first portion may include an initial, three-month portion of the twelve-month target temporal interval, and the second portion may include a subsequent, nine-month portion of the twelve-month target temporal interval. Further, the predetermined threshold interval associated with the past-due payment (e.g., a corresponding past-due period) may include, but is not limited to, ninety calendar days.

As described herein, the machine-learning or artificial-intelligence process may include an ensemble or decision-tree process, such as a gradient-boosted decision-tree process (e.g., the XGBoost model), and in some examples, the distributed computing components of FI computing system 130 may adaptively train the machine-learning or artificial-intelligence process using training datasets associated with a first prior temporal interval (e.g., a “training” interval) and validation datasets associated with a second, and distinct, prior temporal interval (e.g., an out-of-time “validation” interval). Responsive to a determination that the machine-learning or artificial-intelligence process is adaptively trained and ready for deployment, the distributed components of FI computing system 130 may perform any of the exemplary processes described herein to generate one or more elements of model data (e.g., model data 190 of FIG. 1C) that include the model parameters of the adaptively trained machine-learning or artificial-intelligence process, and to generate one or more elements of input data (e.g., input data 192 of FIG. 1C) that characterizes a composition of an input dataset for the adaptively trained machine-learning or artificial-intelligence process.

Further, computing system 130 may receive elements of data characterizing one or more customers of the financial institution that hold non-delinquent RESL products issued by the financial institution, such as, but not limited to, the home mortgage products and HELOC products described herein. In some instances, the distributed computing components of FI computing system 130 may perform any of the exemplary processes described herein to generate a input dataset for each of the one or more customer based on feature values extracted from, or derived from the received elements of customer data (e.g., in accordance with input data 192), and to apply an adaptively trained machine-learning or artificial-intelligence process (e.g., the adaptively trained, gradient-boosted, decision-tree process described herein) to each of the customer-specific input datasets in accordance with the elements of model data 190. Based on the application of the adaptively trained machine-learning or artificial-intelligence process to each of the input datasets, the distributed components of FI computing system 130 generate a customer-specific element of output data associated with corresponding ones of the customer-specific input datasets, and to provision the customer-specific elements of output data to one or more additional computing systems associated with the financial institution, such as, but not limited to RESL computing system 110.

As described herein, each of the elements of customer-specific output data may include a numerical value indicative of a likelihood that a corresponding one of the customers, and the issued, non-delinquent RESL product held by the corresponding customer, represents a risk of early-stage delinquency. Further, and based on the customer-specific elements of output data, RESL computing system 110 may assess the risk of early-stage delinquency posed by corresponding ones of the customers, and perform any of the exemplary processes described herein to identify one or more treatments that are appropriate to the corresponding ones of the customers and appropriate to the assessed risk of early-stage delinquency. Through an application of the identified remediation processes or treatments to the corresponding ones of the customers, certain of the exemplary processes described herein may enable RESL computing system 110 to mitigate the risk of the early-stage delinquency for at least portion of these customers, and to reduce an exposure of the financial institution to these potential early-stage delinquencies.

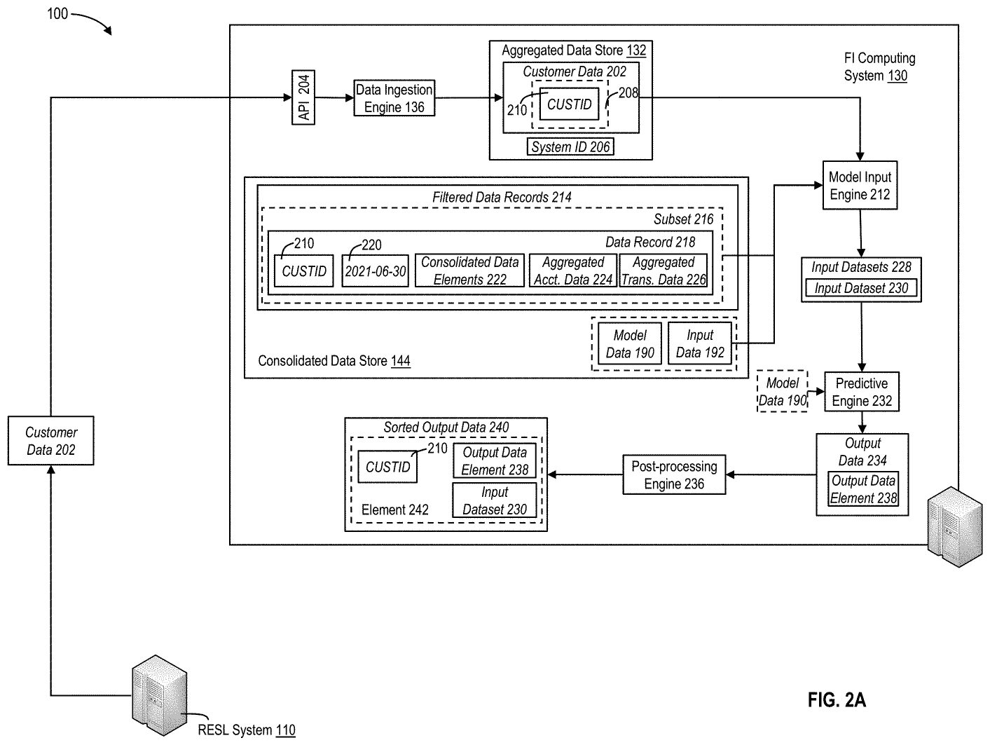

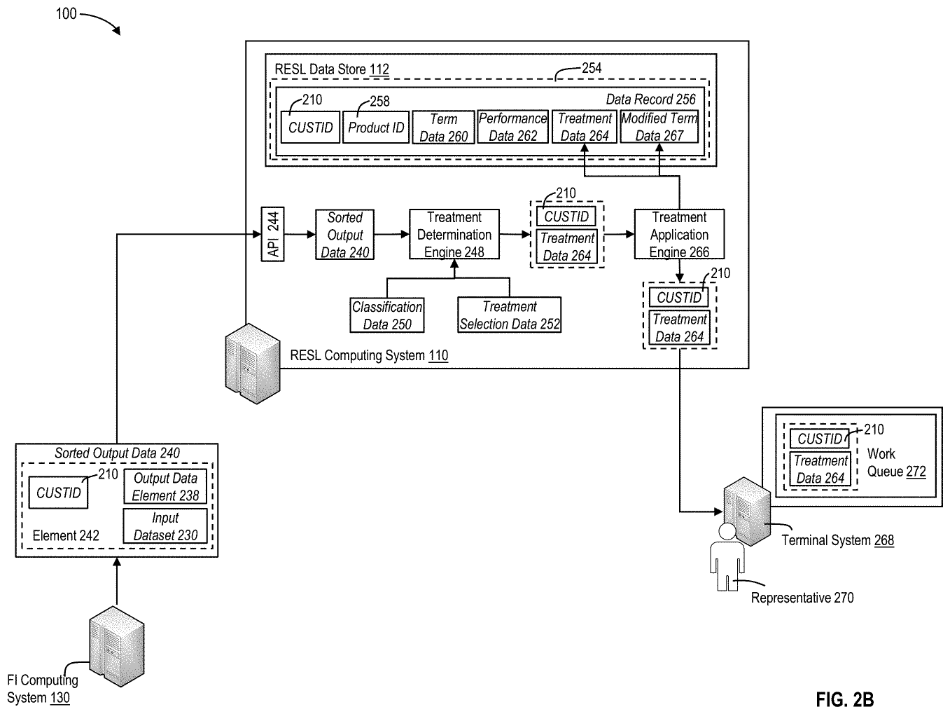

Referring to FIG. 2A, aggregated data store 132 of FI computing system 130 may maintain one or more elements of customer data 202. Each of the one or more elements of customer data 202 may be associated with a customer of the financial institution that holds an issued RESL product (such as, but not limited to, one of the home mortgage products or HELOC products described herein), and further, each of the customers may be compliant with the terms and conditions associated with the issued RESL product, including the corresponding payment schedule (e.g., none of the issued RESL products held by the customers are currently delinquent). FI computing system 130 may, for example, receive all, or a selected portion, of customer data elements 202 from RESL computing system 110, and in some instances, an application program executed by the one or more processors of RESL computing system 110 (not illustrated in FIG. 2A) may cause RESL computing system 110 to transmit portions of customer data elements 202 across network 120 to FI computing system 130.

In some examples, the executed application program may perform operations that cause RESL computing system 110 to transmit the portions of customer data elements 202 across network 120 to FI computing system 130 in accordance with a predetermined temporal schedule, e.g., on a monthly basis. Further, the executed application program may all encrypt each of the portions of customer data elements 202 using a corresponding encryption key, such as a public cryptographic key associated with FI computing system 130, and a programmatic interface established and maintained by FI computing system 130, such as application programming interface (API) 204, may receive the portions of customer data 202 from RESL computing system 110.

API 204 may, for example, route each of the elements of customer data 202 to executed data ingestion engine 136, which may perform operations that store the elements of customer data 202 within one or more tangible, non-transitory memories of FI computing system 130, such as within aggregated data store 132. In some instances, and as described herein, the received elements of customer data 202 may be encrypted, and executed data ingestion engine 136 may perform operations that decrypt each of the encrypted elements of customer data 202 using a corresponding decryption key (e.g., a private cryptographic key associated with FI computing system 130) prior to storage within aggregated data store 132. Further, although not illustrated in FIG. 2A, aggregated data store 132 may also store one or more additional elements of customer data identifying customers of the financial institution that hold corresponding ones of the issued, non-delinquent RESL products, and executed data ingestion engine 136 may perform one or more synchronization operation that merge the received elements of customer data 202 with the previously stored elements of customer data, and that eliminate any duplicate elements existing among the received elements of customer data 202 with the previously stored elements of customer data (e.g., through an invocation of an appropriate Java-based SQL “merge” command).

As described herein, each of the elements of customer data 202 may be associated with, and include a unique identifier of, a customer of the financial institution that holds a non-delinquent RESL product issued by the financial institution, such as one of the home mortgage products or HELOC products described herein. Further, each of the elements of customer data 202 may be stored within aggregated data store 132 in conjunction, or association, with a system identifier 206 of RESL computing system 110, such as an Internet Protocol (IP) address or a media access control (MAC) address. For example, as illustrated in FIG. 2A, element 208 of customer data 202 may be associated with a particular one of the customers of the financial institution that holds a non-delinquent RESL product issued by the financial institution, and may include a customer identifier 210 assigned to the particular customer by FI computing system 130, an alphanumeric character string “CUSTID.” Further, although not illustrated in FIG. 2A, each additional, or alternate, element of customer data 202 may be associated with an additional customer of the financial institution that holds one of the non-delinquent RESL products issued by the financial institution, and may include a unique customer identifier associated with that additional customer.

In some instances, FI computing system 130 may perform any of the exemplary processes described herein to generate an input dataset associated with each of the customers identified by the data records of customer data 202, and to apply the adaptively trained, gradient-boosted, decision-tree process described herein to each of the input datasets. For example, a model input engine 212 executed by FI computing system 130 may perform operations that access the elements of customer data 202 maintained within aggregated data store 132, and that obtain the customer identifier maintained within a corresponding one of the accessed the data records of ingested customer data 138. As illustrated in FIG. 2A, executed model input engine 212 may access element 208 (e.g., as maintained within aggregated data store 132) and obtain customer identifier 210, which includes, but is not limited to, the alphanumeric character string “CUSTID” assigned to the particular customer of the financial institution.

Executed model input engine 212 may also access consolidated data store 144, and perform operations that identify, within filtered data records 214, a subset 216 of filtered data records that include customer identifier 210 and as such, are associated with the particular customer of the financial institution identified by element 208. Each of subset 216 may also include a temporal identifier of a corresponding temporal interval, and one or more additional elements of consolidated data, aggregate account data, and/or aggregate transaction data that identify and characterize the particular customer and the interactions between the particular customer and the financial institution, as described herein. By way of example, data record 218 of subset 216 may also include corresponding temporal identifier 220 (e.g., “2021-06-30,” indicating a temporal interval spanning Jun. 1, 2021, through Jun. 30, 2021), and consolidated data elements 222, which identify and characterize the particular customer associated with customer identifier 210 during the temporal interval spanning Jun. 1, 2021, through Jun. 30, 2021. Data record 218 may also include elements of aggregated account data 224, which characterize the usage of the financial products or instruments held by the customer associated with customer identifier 210 during the temporal interval spanning Jun. 1, 2021, through Jun. 30, 2021, and elements of aggregated transaction data 226 characterizing a spending, purchasing, or payment habit of the customer associated with customer identifier 210 during the temporal interval spanning Jun. 1, 2021, through Jun. 30, 2021. Although not illustrated in FIG. 2A, data record 218 may include one or more data flags indicative of an established consistency of data record 218 with one or more filtration criteria, such as, but not limited to, the product- and delinquency-specific filtering criteria described herein.

In some examples, FI computing system 130 may perform any of the exemplary process described herein to generate each of consolidated data elements 222, the elements of aggregated account data 224, and the elements of aggregated transaction data 226, and to package consolidated data elements 222, aggregated account data 224, and aggregated transaction data 226 into corresponding portions of data record 218 upon a determination that data record 218, and the customer associated with customer identifier 210, each satisfy one or more of the filtration criteria described herein during the temporal interval represented by temporal identifier 220. Further, although not illustrated in FIG. 2A, each additional, or alternate, data records within subset 216 may include customer identifier 210, a temporal identifier of a corresponding temporal interval, corresponding elements of consolidated data, aggregated account data, and transaction data that identify and characterize the particular customer during the corresponding temporal interval, and one or more data flags indicative of an established consistency of each of the additional, or alternate, data records with the one or more filtration criteria, such as, but not limited to, the product- and delinquency-specific filtering criteria described herein.

Executed model input engine 212 may also perform operations that obtain, from consolidated data store 144, elements of input data 192 characterize a composition of an input dataset for the adaptively trained, gradient-boosted, decision-tree process. In some instances, executed model input engine 212 may parse input data 192 to obtain the composition of the input dataset, which not only identifies the elements of customer-specific data included within each input data set dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 176, as described herein.

In some instances, and based on the parsed portions of input data 192, executed model input engine 212 may perform operations that identify, and obtain or extract, one or more of the input feature values from one or more of data records maintained within subset 216 of filtered data records 214 Executed model input engine 212 may also package the obtained, or extracted, input feature values within a corresponding one of input datasets 228, such as input dataset 230 associated with the particular customer identified by element 208 of customer data 202, in accordance with their respective, specified sequences or positions. Further, in some examples, and based on the parsed portions of input data 192, executed model input engine 212 may perform operations that compute, determine, or derive one or more of the input features values based on elements of data extracted or obtained from the subset 216 of filtered data records 214, and that package each of the computed, determined, or derived input feature values into portions of input dataset 230 in accordance with their respective, specified sequences or positions.

Through an implementation of these exemplary processes, executed model input engine 212 may populate an input dataset associated with the particular customer of the financial institution identified by data record 210, such as input dataset 230 of input datasets 228, with input feature values obtained or extracted from, or computed, determined or derived from element of data within, the data records of subset 216. Further, in some instances, executed model input engine 212 may also perform any of the exemplary processes described herein to generate, and populate with input feature values, an additional one of input datasets 228 for each of the additional, or alternate, customers of the financial institution associated with additional, or alternate, elements of customer data 202. Executed model input engine 212 may package each of the discrete, customer-specific input datasets within input datasets 228, and executed model input engine 212 may provide input datasets 228 as an input to a predictive engine 232 executed by the one or more processors of FI computing system 130.

As illustrated in FIG. 2A, executed predictive engine 232 may perform operations that obtain, from consolidated data store 144, model data 190 that includes one or more model parameters of the adaptively trained, gradient-boosted, decision-tree process. For example, and as described herein, the model parameters included within model data 190 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some examples, and based on portions of model data 190, executed predictive engine 232 may perform operations that establish a plurality of nodes and a plurality of decision trees for the adaptively trained, gradient-boosted, decision-tree process, each of which receive, as inputs (e.g., “ingest”), corresponding elements of input datasets 228. Further, and based on the execution of predictive engine 232, and on the ingestion of input datasets 228 by the established nodes and decision trees of the adaptively trained, gradient-boosted, decision-tree process, FI computing system 130 may perform operations that apply the adaptively trained, gradient-boosted, decision-tree process to each of the input datasets of input datasets 228, including input dataset 230, and that generate an element of output data 234 associated with a corresponding one of input datasets 228, and as such, a corresponding one of the customers identified by the elements of customer data 202.

As described herein, each of the generated elements of output data 234 may include a numerical score indicative of a predicted likelihood that, at a temporal prediction point t_{pred}, a corresponding one of the customers will be associated with both (i) a non-occurrence of a delinquency event involving an issued RESL product during a first portion Δt_{clean} of a target temporal interval Δt_{target} (e.g., an initial, three-month portion of a twelve-month target temporal interval Δt_{target}) and (ii) an occurrence of a default event involving the corresponding customer and the issued RESL product during a second portion Δt_{delinquency} of the target temporal interval Δt_{target} (e.g., a subsequent, nine-month portion of the twelve-month target temporal interval Δt_{target}). In some examples, the numerical score within each of the elements of output data 234 may include a value of zero or a value of unity, with zero being indicative of a minimal predicted likelihood, and unity being indicative of a maximum predicted likelihood.

In some instances, executed predictive engine 232 may provide the generated elements of output data 234 (e.g., either alone, or in conjunction with corresponding ones of input datasets 228) as an input to a post-processing engine 236 executed by the one or more processors of FI computing system 130. In some instances, and upon receipt of the generated elements of output data 234 (e.g., and additionally, or alternatively, the corresponding ones of input datasets 228), executed post-processing engine 236 may perform operations that access the customer identifiers maintained within each of the elements of customer data 202 (e.g., as maintained within aggregated data store 132), and associate each of the accessed customer identifiers with a corresponding one of the elements of output data 234. By way of example, element 238 of output data 234 may be associated with the particular customer identified by element 208 of customer data 202 (e.g., that includes customer identifier 210), and may include a numerical score of unity, which indicates a maximum likelihood that the particular customer, and the corresponding issued RESL product, represents an early-stage delinquency risk (e.g., a maximum likelihood that the particular customer will be associated with both (i) the non-occurrence of the delinquency event involving the issued RESL product during first portion Δt_{clean} of target temporal interval Δt_{target} and (ii) the occurrence of the default event involving the issued RESL product during the second portion Δt_{delinquency} of the target temporal interval Δt_{target}).

Executed post-processing engine 236 may, in some instances, associate the customer identified by element 208, and corresponding customer identifier 210, of with element 238 of output data 234, and further, with all or a selected potion of the input dataset 230 (e.g., a predetermined number of feature values of input dataset 230 characterized by corresponding ones of the largest Shapley feature value contributions). Further, executed post-processing engine 236 may perform any of these exemplary processes to associate each additional, or alternate, one of the elements of output data 234 with a corresponding one of the elements of customer data 202 and corresponding ones of the customer identifiers, and further, with all, or a selected potion, of a corresponding one of input datasets 228.

Further, executed post-processing engine 236 may perform operations that sort the associated customer identifiers (and elements of customer data 202), the associated elements of output data 240, and in some instances, the associated portions of input datasets 228, based on the numerical scores maintained within each of the elements of output data 240. Executed post-processing engine 236 may also perform operations that generate elements of sorted output data 240 that include the associated, and now sorted, data records of ingested customer data 138 and elements of output data 240. For example, and for the particular customer associated with customer identifier 210, the elements of sorted output data 240 may include a corresponding sorted element 242 that associates together customer identifier 210, element 238 of output data 234 (which specifies a numerical score of unity for the customer associated with customer identifier 210), and in some instances, one or more of the feature values maintained within input dataset 230 (e.g., the predetermined number of feature values characterized by corresponding ones of the largest Shapley feature value contributions). Each additional, or alternate, element of sorted output data 240 may include, for a corresponding one of the customers, a corresponding one of the customer identifiers, a corresponding element of output data 234, and/or one or more of the feature values maintained a corresponding one of input datasets 228.

In some instances, executed post-processing engine 236 may additionally perform operations that cause FI computing system 130 to transmit all, or a selected portion, of the elements of sorted output data 240 across network 120 to RESL computing system 110 (e.g., based on system identifier 206). By way of example, the selected portion of the elements of sorted output data 240 data may include, but is not limited to, a subset of the elements of sorted output data 240 associated with numerical scores that exceed a predetermined threshold value, such as, but not limited to, a numerical score of 0.75 or a predetermined numerical score associated with customers deemed by the financial institution to represent an emerging or high risk of early-stage delinquencies involving corresponding ones of the RESL products. Additionally, or alternatively, the selected portion of the elements of sorted output data 240 data may include a predetermined number of the discrete elements associated with the largest of the numerical scores (e.g., 800 of the elements of sorted output data 240 associated the highest of the numerical scores), or may include a portion of the elements of sorted output data 240 associated with numerical scores that satisfy one or more statistical criteria (e.g., numerical scores that exceed a mean numerical score, numerical scores that exceed the mean numerical score by one or more standard deviations, etc.). Further, in some examples, and prior to transmission across network 120 to RESL computing system 110, executed post-processing engine 236 may also encrypt each, or the selected potion, of the elements of sorted output data using a corresponding encryption key, such as, but not limited to, a public cryptographic key associated with RESL computing system 110.

Referring to FIG. 2B, a programmatic interface established and maintained by RESL computing system 110, such as application programming interface (API) 244, may receive the elements of sorted output data 240, and may route the elements of sorted output data 240 to a treatment determination engine 248 executed by the one or more processors of RESL computing system 110. In some instances, not illustrated in FIG. 2B, FI computing system 130 may also encrypt all, or a selected portion of, the elements of sorted output data 240 prior to transmission across communications network 120 using a corresponding encryption key (e.g., a public cryptographic key associated with RESL computing system 110), and executed treatment determination engine 248 may perform operations that decrypt the encrypted elements of sorted output data 240 using a corresponding decryption key (e.g., a private cryptographic key associated with RESL computing system 110).

In some instances, executed treatment determination engine 248 may perform operations that parse the elements of sorted output data 240 (including element 242) and obtain, from each of the elements of sorted output data 240, a customer identifier associated with a corresponding one of the customers of the financial institution and a numerical value indicative of a likelihood that the corresponding customer, and the issued RESL product held by the corresponding customer, represents a risk of early-stage delinquency. Further, and based on the obtained numerical values, executed treatment determination engine 248 may perform any of the exemplary processes described herein to assess the risk of early-stage delinquency posed by the corresponding ones of the customers, and to identify one or more remediation processes or treatments that are applicable to the corresponding ones of the customers and appropriate to the assessed risk of early-stage delinquency. Through an application of the identified remediation processes or treatments to the corresponding ones of the customers, certain of the exemplary processes described herein may enable RESL computing system 110 to mitigate the risk of the early-stage delinquency for at least a portion of these customers, and to reduce an exposure of the financial institution to these potential early-stage delinquencies.

By way of example, executed treatment determination engine 248 may element 242 of sorted output data 240 that includes, among other things, customer identifier 210 of the particular customer of the financial institution and element 238 of output data 234, which specifies a numerical score of unity for the particular customer. As described herein, the numerical score of unity may indicate a maximum likelihood that the particular customer, and the corresponding issued RESL product held by that particular customer, represent an early-stage delinquency risk to the financial institution (e.g., a maximum likelihood that the particular customer will be associated with both (i) the non-occurrence of the delinquency event involving the issued RESL product during first portion Δt_{clean} of target temporal interval Δt_{target} and (ii) the occurrence of the default event involving the issued RESL product during the second portion Δt_{delinquency} of the target temporal interval Δt_{target}. In some examples, illustrated in FIG. 2B, executed treatment determination engine 248 may perform operations that obtain classification data 250, which establishes, among other things, a rubric for assigning the particular customer, and the corresponding issued RESL product held by that particular customer, to one of a plurality of risk levels based on the corresponding numerical score.

For example, classification data 250 may establish that a customer of the financial institution associated with a numerical score ranging from zero to 0.4 may be characterized as a low risk of early-stage delinquency, and that a customer of the financial institution associated with a numerical score ranging from 0.4 to 0.75 may be characterized as a medium, or emerging, risk of early-stage delinquency. Further, for a customer of the financial institution associated with a numerical score that exceeds 0.75, classification data 250 may characterize the customer as a high risk of early-stage delinquency. The disclosed embodiments are not limited to these exemplary risk rankings, and to these exemplary ranges of numerical scores, and in other instances, classification data 250 may identify any additional, or alternate, risk level or associated range of numerical values that would be appropriate to the financial institution, the customers of the financial institution, or the issued RESL products.

Further, in some instances, executed treatment determination engine 248 may also obtain treatment selection data 252, which establishes, among other things, one or more product-specific treatments appropriate for each of the RESL products issued by the financial institution and each of the assigned risk levels. As described herein, the issued RESL products may include, but are not limited to, a home mortgage product and a HELOC product, and the elements of treatment selection data 252 may specify, for each of the home mortgage and HELOC products, one or more product-specific treatments appropriate to customers assigned to corresponding ones of the risk levels specified within classification data 250, e.g., the low, medium or merging, and high risks for early-stage delinquency. By way of example, for customers that hold either a home mortgage product or a HELOC product, and that are characterized by a low risk of early-stage delinquency, elements of treatment selection data 252 may specify that these customers should receive content from the financial intuition that enhances their financial literacy and maintain, or reduce, the low risk of early stage delinquency. The content may, for instance, be provisioned to the customers through physical or electronic correspondence (e.g., a physical letter, an email, a text-message, or an in-app notification, etc.), or through voice-based communications (e.g., via a pre-recorded message delivered by telephone, via a call manually generated by a representative of the financial institution).

In some instances, and for a customer that holds a home mortgage product and represents a medium, or emerging, risk of early-stage delinquency, the elements of treatment selection data 252 may specify treatments that include, but are not limited to, a capitalization of the home mortgage product (e.g., to include additional, unpaid interest or fees to the existing principal amount, etc.) or an extension of an amortization of the home mortgage product (e.g., via a modification to an amortization schedule, etc.). Further, and for a customer that holds a HELOC product and represents a medium, or emerging, risk of early-stage delinquency, the elements of treatment selection data 252 may specify treatments that include, but are not limited to, a conversion of the HELOC product from a revolving portion to a term portion, or a payment extension to one or more of the scheduled payments associated with the HELOC product.

Additionally, and for a customer that holds a home mortgage product and represents a high risk of early-stage delinquency, the elements of treatment selection data 252 may specify treatments that include, but are not limited to, a restructuring or a refinancing of the home mortgage product, or a provisioning of credit counseling to the customer, e.g., via the financial institution or by one or more third-party entities. In other instances, and for a customer that holds a HELOC product and represents a high risk of early-stage delinquency, the elements of treatment selection data 252 may specify treatments that include, but are not limited to, a conversion of the HELOC product from a revolving portion to a term portion, a restructuring or a refinancing of the HELOC product, an imposition of a portion or complete hold on a distribution of funds from the HELOC product, a decrease in an amount of credit available to the HELOC product, or provisioning of credit counseling to the customer, e.g., via the financial institution or by one or more third-party entities.

Through an application of one or more of these treatments to a corresponding customer of the financial institution that holds a RESL product, certain of the exemplary processes described herein, when implemented by RESL computing system 110, may maintain or reduce the risk of early-stage delinquency posed by the corresponding customer and the issued RESL product, and reduce an exposure of the financial institution to the early-stage delinquency. Further, the disclosed embodiments are not limited to these exemplary RESL products and to these exemplary risk-level and product-specific treatments, and in other instances, the elements of treatment selection data 252 may identify and specify any additional, or alternate, treatment that would be appropriate to the home mortgage product, the HELOC product, any other RESL products issued by the financial institution, and that would be appropriate to the low, medium or merging, and high levels of risk of early-stage delinquency.

Referring back to FIG. 2B, executed treatment determination engine 248 may obtain, from element 242 of sorted output data 240, customer identifier 210 of the particular customer of the financial institution and element 238 of output data 234, which specifies the numerical score of unity for the particular customer. Executed treatment determination engine 248 may also access customer data records 254 maintained within RESL data store 112, and identify a corresponding one of the accessed customer data records, such as data record 256, that includes customer identifier 210 and that identifies, and characterizes, the particular customer. As described herein, the particular customer of the financial institution may hold a home mortgage product issued by that financial institution, and data record 256 may also include, among other things, a RESL product identifier 258 that identifies the home mortgage product held by the particular customer, term data 260 that identifies one or more terms or conditions of the home mortgage product (e.g., a temporal term, a current interest rate, information specifying whether the home mortgage product is associated with a fixed or variable interest rate, an amortization schedule, etc.), and performance data 262 characterizing the particular customer's interaction with the home mortgage product and prior adherence to the imposed terms and conditions.

In some instances, executed treatment determination engine 248 may establish, based on the RESL product identifier 258, that the particular customer hold the home mortgage product, and may further establish, based on the numerical score (e.g., of unity) and portions of classification data 250, that the particular customer represents a high risk of an early-stage delinquency involving the home mortgage product. Further, executed treatment determination engine 248 may parse the elements of treatment selection data 252 and obtain information specifying one or more appropriate treatments for the particular customer's high risk of early-stage delinquency, such as, but not limited to, a restructuring or a refinancing of the home mortgage product, or a provisioning of credit counseling to the customer, e.g., via the financial institution or by one or more third-party entities. Executed treatment determination engine 248 may package data characterizing the particular customer's high risk of early-stage delinquency, and the information specifying the one or more appropriate treatments into corresponding portions of treatment data 264, and executed treatment determination engine 248 may provision to a treatment application engine 266 executed by the one or more processors of RESL computing system 110, along with customer identifier 210.

Executed treatment application engine 266 may, for example, receive customer identifier 210 and treatment data 264, and may perform any of the exemplary processes described herein to apply the one or more appropriate treatments to the particular customer associated with customer identifier 210 or to the home mortgage product held by that particular customer. As illustrated in FIG. 2B, executed treatment application engine 266 may store treatment data 264 within a corresponding portion of data record 256, e.g., in conjunction with customer identifier 210. Further, in some examples, executed treatment application engine 266 may also perform operations that implement, or prepare to implement, the restructuring or a refinancing of the home mortgage product and that generate elements of modified term data 267 that specify terms and conditions associated with the implementation of the restructuring or a refinancing of the home mortgage product. Executed treatment application engine 266 may also store the elements of modified term data 267 within a corresponding portion of data record 256.

Additionally, or alternatively, executed treatment application engine 266 may transmit customer identifier 210 and treatment data 264 across communications network 120 to a terminal system 268 operated by a representative 270 the financial institution. As illustrated in FIG. 2B, terminal system 268 may perform operations (e.g., via execution of stored software instructions by one or more corresponding processors) that store the customer identifier 210 and treatment data 264 within a portion of one or more tangible, non-transitory memories, such as within a portion of a work queue 272 of the representative, which may provide input to terminal system 268 that applies one or more of the treatments specified within treatment data 264 to the particular customer.

Executed treatment determination engine 248 may also perform any of the exemplary processes described herein to access each additional, or alternate, element of sorted output data 240, and to obtain a corresponding customer identifier and a numerical score indicative of a predicted likelihood that the customer associated with the customer identifier, and the corresponding issued RESL product held by that customer, represent an early-stage delinquency risk to the financial institution. Based on at least the numerical scores, executed treatment determination engine 248 may perform any of the exemplary processes described herein to determine a risk of early-stage delinquency posed by each of the additional, or alternate, ones of the customers of the financial institution (and the RESL products held by these additional, or alternate, customers), and to identify one or more product-specific treatments appropriate to the determined risk associated with each of the each of the additional, or alternate, ones of the customers, and to generate corresponding elements of treatment data that identify and characterize the appropriate treatments. In some instances, executed treatment determination engine 248 may provide each of the generated elements of treatment data as inputs to executed treatment application engine 266, which may perform any of the exemplary processes described herein to apply the appropriate the candidate remediation processes or treatments to corresponding ones of the additional, or alternate, ones of the customers.

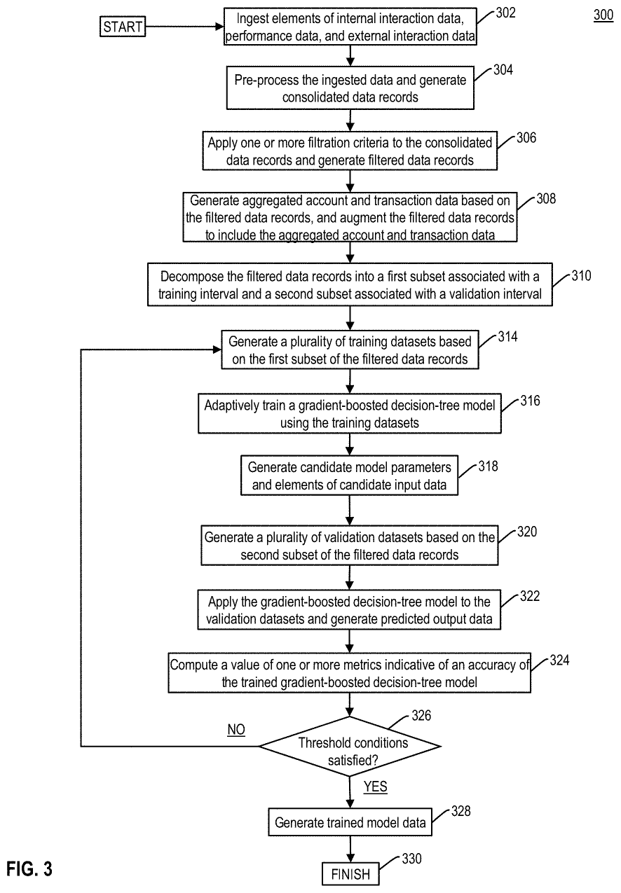

FIG. 3 is a flowchart of an exemplary process 300 for adaptively training a machine-learning or artificial-intelligence process to predict a likelihood of (i) a non-occurrence of a delinquency event involving a customer of the financial institution and an issued RESL product during a first portion of a target temporal interval and (ii) an occurrence of a default event involving the customer of the financial institution and the issued RESL product during a second portion of a target temporal interval, in accordance with some exemplary embodiments. By way of example, a delinquency event involving the customer of the financial institution and the issued RESL product occurs during the first or second portions of the target temporal interval when the customer fails to submit a scheduled payment associated with issued RESL product (e.g., when that scheduled payment becomes “past due”).

As described herein, a default event occurs during the second portion of the target temporal interval when, during the second portion of the target temporal interval, the customer fails to submit a scheduled payment associated with issued RESL product and the scheduled payment remains past due for a predetermined temporal interval. For example, the target temporal interval may include twelve months, the first portion may include an initial, three-month portion of the twelve-month target temporal interval, and the second portion may include a subsequent, nine-month portion of the twelve-month target temporal interval. Further, the predetermined temporal interval associated with the past-due payment (e.g., a corresponding past-due period) may include, but is not limited to, ninety calendar days.

In some examples, the machine-learning or artificial-intelligence process may include an ensemble or decision-tree process, such as a gradient-boosted decision-tree process (e.g., the XGBoost model), and one or more of the exemplary, adaptive training processes described herein may utilize training datasets associated with a first prior temporal interval (e.g., a “training” interval), and validation datasets associated with a second, and distinct, prior temporal interval (e.g., an out-of-time “validation” interval). In some instances, one or more computing systems, such as, but not limited to, one or more of the distributed components of FI computing system 130, may perform one or of the steps of exemplary process 300.

Referring to FIG. 3, FI computing system 130 may establish a secure, programmatic channel of communication with one or more source computing systems, such as source systems 102 of FIG. 1A, and may perform operations to obtain, from the source computing systems, elements of internal interaction data, performance data, and external interaction data that identify and characterize one or more customers of the financial institution during corresponding temporal intervals (e.g., in step 302 of FIG. 3). FI computing system 130 may also perform operations, such as those described herein, that store (or ingest) the obtained elements of internal and external customer data, and the elements of performance data, within one or more accessible data repositories, such as aggregated data store 132 (e.g., also in step 302 of FIG. 3). In some instances, FI computing system 130 may perform the exemplary processes described herein to obtain and ingest the elements of internal and external interaction data, and the credit performance data, in accordance with a predetermined temporal schedule (e.g., on a monthly basis at a predetermined date or time, etc.), or a continuous streaming basis, across the secure, programmatic channel of communication.

Further, FI computing system 130 may perform any of the exemplary processes described herein to pre-process the ingested elements of internal interaction data, delinquency data, and external interaction data (e.g., the elements of customer profile, account, transaction, credit performance, and/or reporting or credit bureau data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with a particular one of the customers, and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of customer profile, account, transaction, credit performance, or credit-bureau data that characterize the particular customer during the corresponding temporal interval associated with the temporal identifier.

In some instances, FI computing system 130 may perform any of the exemplary processes described herein to apply one or more filtration criteria to each of the consolidated data records, and to generate corresponding filtered data records that are consistent with, and satisfy, each of the applied filtration criteria (e.g., in step 306 of FIG. 1), such as, but not limited to, removing customers that hold delinquent or past-due RESL products. As described herein, each of the filtered data records may be associated with a corresponding one of the customers, and may include a corresponding pair of a customer and temporal identifiers, such as those described herein. Further, and in addition to the corresponding pair of customer and temporal identifiers, each of the filtered data records may also include one or more of the consolidated elements of customer profile, account, transaction, credit performance, or credit-bureau data described herein, which characterize the corresponding one of the customers during the corresponding temporal interval associated with the temporal identifier.

By way of example, the filtration criteria may include one or more of the RESL- and delinquency-specific filtration criteria described herein, and each of the filtered data records may identify, and characterize, a corresponding one of the customers of the financial institution that holds a RESL product issued by the financial institution. FI computing system 130 may store each of the filtered data records within one or more accessible data repositories, such as consolidated data store 144 (e.g., also in step 306 of FIG. 3).

FI computing system 130 may also perform any of the exemplary processes described herein to access each of the filtered data records, and based on the consolidated data elements maintained within each of the filtered data records, generate one or more elements of aggregated account data and one or more elements of aggregated account data that characterize the corresponding one of the customers during the corresponding temporal interval, such as one month (e.g., in step 308 of FIG. 3). FI computing system 130 may also perform operations that augment each of the filtered data records to include the corresponding elements of aggregated account and transaction data (e.g., also in step 308).

In some instances, FI computing system 130 may perform any of the exemplary processes described herein to decompose the filtered data records into (i) a first subset of the consolidated data records having temporal identifiers associated with a first prior temporal interval (e.g., the training interval Δt_{training}, as described herein) and (ii) a second subset of the filtered data records having temporal identifiers associated with a second prior temporal interval (e.g., the validation interval Δt_{validation}, as described herein), which may be separate, distinct, and disjoint from the first prior temporal interval (e.g., in step 310 of FIG. 3). By way of example, portions of the filtered data records within the first subset may be appropriate to train adaptively the machine-leaning or artificial process (e.g., the gradient-boosted decision model described herein) during the training interval Δt_{training}, and portions of the filtered records within the second subset may be appropriate to validate the adaptively trained gradient-boosted decision model during the validation interval Δt_{validation}.

In some instances, FI computing system 130 may perform any of the exemplary processes described herein to generate a plurality of training datasets based on elements of data obtained, extracted, or derived from all or a selected portion of the first subset of the filtered data records (e.g., in step 314 of FIG. 3) during the extraction interval Δt_{extract}. By way of example, each of the plurality of training datasets may be associated with a corresponding one of the customers of the financial institution and a corresponding temporal interval, and may include, among other things a customer identifier associated with that corresponding customer and a temporal identifier representative of the corresponding temporal interval, as described herein.

Further, and as described herein, each of the plurality of training datasets may also include elements of data (e.g., feature values) that characterize the corresponding one of the customers during the corresponding temporal interval, the corresponding customer's interaction with the financial institution or with other financial institution during the corresponding temporal interval, and one or more delinquency events involving the corresponding customer and a corresponding credit that occurred during, or remained pending during, at least a portion of the corresponding temporal interval. One or more of the plurality of training datasets may also include an element of ground-truth information, as described herein.

Based on the plurality of training datasets, FI computing system 130 may also perform any of the exemplary processes described herein to train adaptively the machine-learning or artificial-intelligence process (e.g., the gradient-boosted decision-tree process described herein) to predict a likelihood of both (i) a non-occurrence of a delinquency event involving a customer of the financial institution and an issued RESL product during a first portion of the target temporal interval described herein, and (ii) an occurrence of a default event involving the customer and the issued RESL product during a second portion of the target temporal interval described herein (e.g., in step 316 of FIG. 3). For example, and as described herein, FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate model parameters that characterize the adaptively trained machine-learning or artificial-intelligence process, such as, but not limited to, candidate model parameters for the adaptively trained, gradient-boosted, decision-tree process described herein (e.g., in step 318 of FIG. 3). In some instances, and for the adaptively trained, gradient-boosted, decision-tree process, the candidate model parameters included within candidate model data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, FI computing system 130 may perform any of the exemplary processes described herein to generate candidate input data, which specifies a candidate composition of an input dataset for the adaptively trained machine-learning or artificial intelligence process, such as the adaptively trained, gradient-boosted, decision-tree process (e.g., also in step 318 of FIG. 3).

Further, FI computing system 130 may perform any of the exemplary processes described herein to access the second subset of the consolidated data records, and to generate a plurality of validation subsets having compositions consistent with the candidate input data (e.g., in step 320 of FIG. 3). As described herein, each of the plurality of the validation datasets may be associated with a corresponding one of the customers of the financial institution, and with a corresponding temporal interval within the validation interval Δt_{validafion}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the customers, and obtained, extracted, or derived from corresponding ones of the accessed second subset of the filtered data records.

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 322 of FIG. 3). As described herein, each of the generated elements of output data may be associated with a respective one of the validation datasets and as such, a corresponding one of the customers of the financial institution. Further, each of the generated elements of output data may also include a numerical score (e.g., ranging from zero to unity) indicative of a predicted likelihood that the corresponding one of the customers will be associated with both (i) a non-occurrence of a delinquency event involving an issued RESL product during a first portion of the target temporal interval described herein, and (ii) an occurrence of a default event involving the issued RESL product during a second portion of the target temporal interval described herein.

Further, and as described herein, the distributed components of FI computing system 130 may perform any of the exemplary processes described herein in parallel to validate the adaptively trained, gradient-boosted, decision-tree process described herein based on the application of the adaptively trained, gradient-boosted, decision-tree process (e.g., configured in accordance with the candidate model parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 324 of FIG. 3), and to determine whether all, or a selected portion of, the computed metric values satisfy one or more threshold conditions for a deployment of the adaptively trained machine-learning or artificial intelligence process (e.g., in step 326 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve or a computed value of an AUC for a receiver operating characteristic (ROC) curve associated with the adaptively trained, gradient-boosted, decision-tree process.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, FI computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 326; NO), FI computing system 130 may establish that the adaptively trained machine-learning or artificial-intelligence process (e.g., the adaptively trained, gradient-boosted, decision-tree process) is insufficiently accurate for deployment and real-time application to the elements of customer profile, account, transaction, insolvency, or credit-bureau data described herein. Exemplary process 300 may, for example, pass back to step 314, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 326; YES), FI computing system 130 may deem the machine-learning or artificial intelligence process (e.g., the gradient-boosted, decision-tree process described herein) adaptively trained and ready for deployment and real-time application to the elements of customer profile, account, transaction, credit performance, or credit-bureau data described herein, and may perform any of the exemplary processes described herein to generate trained model data that includes the candidate model parameters and candidate input data associated with the of the adaptively trained machine-learning or artificial intelligence process (e.g., in step 328 of FIG. 3). Exemplary process 300 is then complete in step 330.

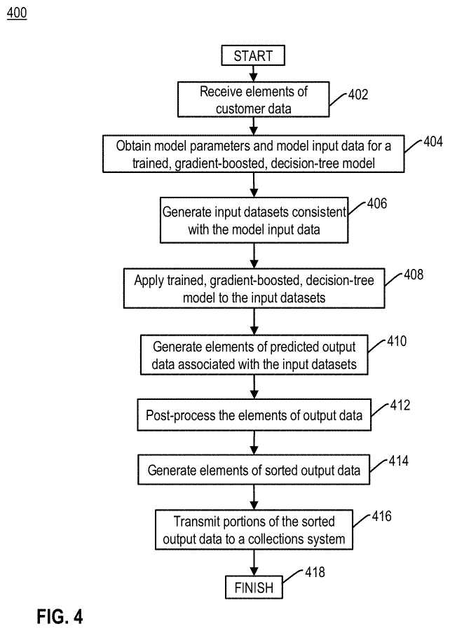

FIG. 4 is a flowchart of an exemplary process 400 for predicting a likelihood of (i) a non-occurrence of a delinquency event involving a customer of the financial institution and an issued RESL product during a first portion of a target temporal interval and (ii) an occurrence of a default event involving the customer of the financial institution and the issued RESL product during a second portion of the target temporal interval, in accordance with some exemplary embodiments. By way of example, a delinquency event involving the customer of the financial institution and the issued RESL product occurs during the first or second portions of the target temporal interval when the customer fails to submit a scheduled payment associated with issued RESL product (e.g., when that scheduled payment becomes “past due”).

As described herein, a default event occurs during the second portion of the target temporal interval when, during the second portion of the target temporal interval, the customer fails to submit a scheduled payment associated with issued RESL product and the scheduled payment remains past due for a predetermined temporal interval. For example, the target temporal interval may include twelve months, the first portion may include an initial, three-month portion of the twelve-month target temporal interval, and the second portion may include a subsequent, nine-month portion of the twelve-month target temporal interval. Further, the predetermined temporal interval associated with the past-due payment (e.g., a corresponding past-due period) may include, but is not limited to, ninety calendar days.

In some instances, the machine-learning or artificial-intelligence process may include an ensemble or decision-tree process, such as a gradient-boosted decision-tree process (e.g., the XGBoost model), and one or more of the exemplary, adaptive training processes described herein may utilize, or leverage, training datasets associated with a first prior temporal interval (e.g., a “training” interval), and validation datasets associated with a second, and distinct, prior temporal interval (e.g., an out-of-time “validation” interval). In some instances, one or more computing systems, such as, but not limited to, one or more of the distributed components of FI computing system 130, may perform one or of the steps of exemplary process 400, as described herein.

Referring to FIG. 4, FI computing system 130 may perform any of the exemplary processes described herein to receive elements of customer data from an additional computing system associated with the financial institution, such as RESL computing system 110 (e.g., in step 402 of FIG. 4). As described herein, each element of the customer data (e.g., structured or unstructured data records, etc.) may be associated with a corresponding customer of the financial institution that holds a non-delinquent RESL product, such as, but not limited to, a home mortgage product or a HELOC product. In some instances, FI computing system 130 may receive the elements of customer data from RESL computing system 110 in accordance with a predetermined temporal schedule, and each of the received elements of customer data may include, but not is not limited to, a unique customer identifier of the corresponding customer, such as an alphanumeric character string.

In some instances, FI computing system 130 may perform any of the exemplary processes described herein to generate an input dataset associated with each of the corresponding customers, and to apply the adaptively trained, gradient-boosted, decision-tree process described herein to each of the input datasets in accordance with the predetermined temporal schedule, such as, but not limited to, at a predetermined time on the last day of the month. For example, FI computing system 130 may obtain one or more model parameters that characterize the adaptively trained machine-learning or artificial-intelligence process (e.g., the adaptively trained, gradient-boosted, decision-tree process described herein) and elements of model input data that specify a composition of an input dataset for the adaptively trained machine-learning or artificial-intelligence process (e.g., in step 404 of FIG. 4).

In some instances, and for the adaptively trained, gradient-boosted, decision-tree process described herein, the one or more model parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, the elements of model input data may specify the composition of the input dataset for the adaptively trained, gradient-boosted, decision-tree process, which not only identifies the elements of customer-specific data included within each input data set dataset (e.g., input feature values, as described herein), but also a specified sequence or position of these input feature values within the input dataset.

FI computing system 130 may access filtered data records associated with one or more customers of the financial institution, and may perform any of the exemplary processes described herein to generate, for each of the one or more customers, an input dataset having a composition consistent with the elements of model input data (e.g., in step 406 of FIG. 4). In some instances, FI computing system 130 may generate the input datasets for each of these customers in accordance with the predetermined schedule described herein, such as, but not limited to, at the predetermined time on the last day of the month).

Further, and based on the one or more obtained model parameters, FI computing system 130 may perform any of the exemplary processes described herein to apply the adaptively trained machine-learning or artificial-intelligence process (e.g., the adaptively trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4). For example, and based on the one or more obtained model parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the customer-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the customer-specific input datasets and that generate the customer-specific elements of the output data associated with the customer-specific input datasets.

As described herein, each of the customer-specific elements of output data may include a numerical score indicative of a predicted likelihood that the corresponding customer will be associated with (i) a non-occurrence of a delinquency event involving the issued RESL product during a first portion of a target temporal interval and (ii) an occurrence of a default event involving the customer of the financial institution and the issued RESL product during a second portion of the target temporal interval. In some examples, the numerical score within each of the customer-specific elements of output data may be indicative of the predicted likelihood (e.g., a risk) that the corresponding customer, and the issued RESL product, will be involved in an early-stage delinquency, and the numerical value may range from zero to unity, with zero being indicative of a minimal predicted likelihood, and unity being indicative of a maximum predicted likelihood.

In step 412 of FIG. 4, FI computing system 130 may perform any of the exemplary processes described herein to post-process the customer-specific elements of output data and, among other things, associate each of the customer-specific elements of output data with a corresponding data record of the received customer data. Further, FI computing system 130 may also perform any of the exemplary processes to sort the associated data records and customer-specific elements of output data based on magnitudes of the corresponding numerical scores (e.g., in step 414 of FIG. 4). FI computing system 130 may perform any of the exemplary processes described herein to transmit all, or a selected portion of, the elements of sorted output data across communications network 120 to the additional computing system associated with the financial institution, such as RESL computing system 110 (e.g., in step 416 of FIG. 4).

As described herein, RESL computing system 110 may receive the elements of sorted output data from FI computing system 130, and may perform any of the exemplary processes described herein that parse each of the elements of sorted output data to obtain a numerical score for a corresponding one of the customers of the financial institution. Based on the obtained numerical score, RESL computing system 110 may perform any of the exemplary processes described herein to determine, for corresponding ones of the customers, a risk that the corresponding customer, and the corresponding issued RESL product, will be involved in an early-stage delinquency, and to identify and apply one or more appropriate treatments to the corresponding customers, which may mitigate the risk of the early-stage delinquency or reduce an exposure of the financial institution to the early-stage delinquency. Exemplary process 400 is then complete in step 418.

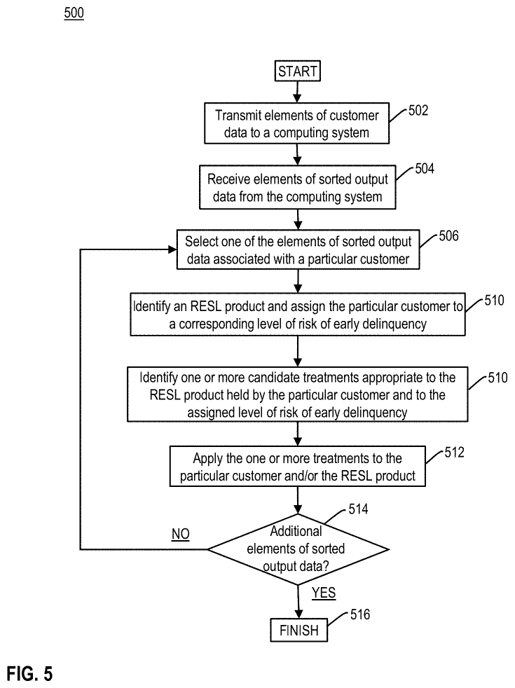

FIG. 5 is a flowchart of an exemplary process 500 for mitigating occurrences of early-stage delinquent events involving customers of a financial institution and RESL products held by these customers, in accordance with come exemplary embodiments. In some instances, one or more computing systems, such as, but not limited to, RESL computing system 110, may perform one or of the steps of exemplary process 500, as described herein.

Referring to FIG. 5, RESL computing system 110 may perform any of the exemplary processes described herein to generate one or more elements of customer data (e.g., discrete data records, etc.), and to transmit the generated elements of customer data across communications network 120 to FI computing system 130 (e.g., in step 502 of FIG. 5). In some instances, RESL computing system 110 may perform operations that generate and transmit the elements of customer data to FI computing system 130 in accordance with a predetermined schedule, such as, but not limited to, on a monthly basis at a predetermined time.

As described herein, each of the elements of customer data may be associated with a corresponding customer of the financial institution that holds a non-delinquent RESL product, such as a home mortgage product or a HELOC product, and each of the elements of customer data may include a unique customer identifier associated with the corresponding customer. In some examples, FI computing system 130 may receive the elements of the customer data, and based on the received elements of customer data, he distributed components of FI computing system 130 may perform any of the exemplary processes described herein to generate a customer-specific input dataset associated with each of the corresponding customers, and to apply the adaptively trained, gradient-boosted, decision-tree process described herein to each of the customer-specific input datasets.

Based on the application of the adaptively trained, gradient-boosted, decision-tree process described herein to each of the input datasets, the distributed components of FI computing system 130 may perform any of the exemplary processes described herein to generate customer-specific elements of output data. As described herein, each of the customer-specific elements of output data may include a numerical score indicative of a predicted likelihood that the corresponding customer will be associated with (i) a non-occurrence of a delinquency event involving the issued RESL product during a first portion of a target temporal interval and (ii) an occurrence of a default event involving the customer of the financial institution and the issued RESL product during a second portion of the target temporal interval. In some examples, the numerical score within each of the customer-specific elements of output data may be indicative of the predicted likelihood (e.g., a risk) that the corresponding customer, and the issued RESL product, will be involved in an early-stage delinquency, and the numerical value may range from zero to unity, with zero being indicative of a minimal predicted likelihood, and unity being indicative of a maximum predicted likelihood. The distributed components of FI computing system 130 may also perform any of the exemplary processes described herein to associate each of the customer-specific elements of output data with a corresponding customer identifier (and in some instances, to one or more of the input features within the customer-specific input dataset), to sort the associated customer identifiers and customer-specific elements of output data in accordance with the numerical scores, and to generate elements of sorted output data that includes corresponding ones of the sorted, and associated, customer identifiers and customer-specific elements of output data. As described herein, FI computing system 130 may transmit the elements of sorted output data across communications network 120 to RESL computing system 110.

Referring back to FIG. 5, RESL computing system 110 may receive the elements of sorted output data from FI computing system 130 and may store the received elements of sorted output data within a locally accessible data repository (e.g., in step 504 of FIG. 5). In some instances, RESL computing system 110 may select one of the elements of sorted output data associated with a particular customer of the financial institution for processing (e.g., in step 506 of FIG. 5), and may perform any of the exemplary processes described herein to identify the RESL product held by that particular customer (e.g., one of the home mortgage products or HEO products described herein), and based on the numerical score of the particular customer, assign the particular customer to a corresponding level of risk of early delinquency (e.g., in step 508 of FIG. 5). As described herein, the levels of risk may include, but are not limited to, low risk, medium or emerging risk, or high risk of early-stage delinquency.

RESL computing system 110 may also perform any of the exemplary processes described herein to identify one or more candidate treatments that would be appropriate to the RESL product held by the particular customer and to the assigned level of risk of early delinquency (e.g., in step 510 of FIG. 5). RESL computing system 110 may also perform any of the exemplary processes described herein to apply the one or more appropriate treatments to the particular customer and/or to the RESL product held by the particular customer (e.g., in step 512 of FIG. 5). In some instances, and through an application of the one or more appropriate treatments to the particular customer and/or to the RESL product held by the particular customer, RESL computing system 110 to mitigate the risk of the early-stage delinquency for the particular customer, and to reduce an exposure of the financial institution to the potential early-stage delinquency.

RESL computing system 110 may also determine whether additional elements of the sorted output data await processing and identification of appropriate treatments (e.g., in step 514 of FIG. 5). If RESL computing system 110 were to determine that additional elements of the sorted output data await processing (e.g., step 514; YES), exemplary process 500 may pass back to step 506, and RESL computing system 110 may access an additional one of the elements of sorted output data associated with a particular customer of the financial institution for processing using any of the exemplary processes operations herein. Alternatively, if RESL computing system 110 were to determine no additional elements of the sorted output data await processing (e.g., step 514; NO), exemplary process 500 is then complete in 516.

### C. Exemplary Hardware and Software Implementations

Examples of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to application programming interface (APIs) 134, 204, and 244, ingestion engine 136, pre-processing engine 140, filtration engine 152, aggregation engine 158, training engine 172, training input module 176, adaptive training and validation module 182, tuning module 183, model input engine 212, predictive engine 232, post-processing engine 236, treatment determination engine 248, and treatment application engine 266 can be implemented as one or more computer programs, i.e., one or more modules of computer program instructions encoded on a tangible non-transitory program carrier for execution by, or to control the operation of, a data processing apparatus (or a computer system or a computing device).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” (e.g., the FI computing system and the device described herein) refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user (e.g., the customer or employee described herein), embodiments of the subject matter described in this specification can be implemented on a computer having a display unit, such as a CRT (cathode ray tube) or LCD (liquid crystal display) monitor, a TFT display, or an OLED display, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. The section headings used herein are for organizational purposes only, and are not to be construed as limiting the described subject matter.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of interaction data associated with an extraction interval;
based on an application of a trained artificial intelligence process to the input dataset, generate output data representative of a predicted likelihood of an occurrence of a first event during a first portion of a target interval, the target interval being subsequent to the extraction interval, the first portion of the target interval being separated from the extraction interval by a second portion of the target interval, and the first event being associated with a predetermined temporal duration within the first portion of the target interval; and
transmit at least a portion of the generated output data to a computing system via the communications interface, the computing system being configured to perform operations based on the portion of the output data.

2. The apparatus of claim 1, wherein the at least one processor is further configured to execute the instructions to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

3. The apparatus of claim 2, wherein the at least one processor is further configured to execute the instructions to:
based on the data that characterizes the composition, perform operations that at least one of extract a first feature value from the interaction data or compute a second feature value based on the first feature value; and
generate the input dataset based on at least one of the extracted first feature value or the computed second feature value.

4. The apparatus of claim 1, wherein the output data comprises a numerical score indicative of the predicted likelihood of the occurrence of the first event during the first portion of the target interval.

5. The apparatus of claim 1, wherein the trained artificial intelligence process comprises a trained, gradient-boosted, decision-tree process.

6. The apparatus of claim 1, wherein the at least one processor is further configured to execute the instructions to:
obtain elements of additional interaction data, each of the elements of the additional interaction data comprising a temporal identifier associated with a temporal interval;
based on the temporal identifiers, determine that a first subset of the elements of the additional interaction data are associated with a prior training interval, and that a second subset of the elements of the additional interaction data are associated with a prior validation interval; and
generate a plurality of training datasets based on corresponding portions of the first subset, and perform operations that train the artificial intelligence process based on the training datasets.

7. The apparatus of claim 6, wherein the at least one processor is further configured to execute the instructions to:
generate a plurality of validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

8. The apparatus of claim 1, wherein:
the interaction data is associated with a plurality of customers; and
the at least one processor is further configured to execute the instructions to:
generate input datasets based on the interaction data, each of the input datasets being associated with a corresponding one of the customers;
based on an application of the trained artificial intelligence process to each the input datasets, and generate a corresponding element of the output data representative of a predicted likelihood of a corresponding occurrence of the first event during the first portion of the target interval; and
each of the elements of the output data includes a numerical score indicative of the predicted likelihood of the corresponding occurrence of the first event for a corresponding one of the customers.

9. The apparatus of claim 1, wherein the at least one processor is further configured to execute instructions to:
perform operations that filter the interaction data in accordance with one or more filtration criteria; and
generate the input dataset based on at least a portion of the filtered interaction data.

10. The apparatus of claim 1, wherein:
the first event occurs when a pendency period associated with an occurrence of a second event during the first portion of the target interval exceeds a threshold period; and
the output data is further representative of the predicted likelihood of (i) the occurrence of the first event during the first portion of the target interval and (ii) a non-occurrence of the second event during the second portion of the target interval.

11. The apparatus of claim 1, wherein the computing system is further configured to perform operations that implement one or more treatment processes in accordance based on the portion of the output data, the implementation of the one or more treatment processes reducing the predicted likelihood of the occurrence of the first event during the first portion of the target interval.

12. A computer-implemented method, comprising:
generating, using at least one processor, an input dataset based on elements of interaction data associated with an extraction interval;
based on an application of a trained artificial intelligence process to the input dataset, generating, using the at least one processor, output data representative of a predicted likelihood of an occurrence of a first event during a first portion of a target interval, the target interval being subsequent to the extraction interval, the first portion of the target interval being separated from the extraction interval by a second portion of the target interval, and the first event being associated with a predetermined temporal duration within the first portion of the target interval; and
transmitting, using the at least one processor, at least a portion of the generated output data to a computing system, the computing system being configured to perform operations based on the portion of the output data.

13. The computer-implemented method of claim 12, further comprising:
obtaining, using the at least one processor, (i) one or more parameters that characterize the trained artificial intelligence process and (ii) data that characterizes a composition of the input dataset;
generating, using the at least one processor, the input dataset in accordance with the data that characterizes the composition; and
applying, using the at least one processor, the trained artificial intelligence process to the input dataset in accordance with the one or more parameters.

14. The computer-implemented method of claim 12, further comprising:
based on the data that characterizes the composition, performing, using the at least one processor, operations that at least one of extract a first feature value from the interaction data or compute a second feature value based on the first feature value; and
generating, using the at least one processor, the input dataset based on at least one of the extracted first feature value or the computed second feature value.

15. The computer-implemented method of claim 12, wherein the output data comprises a numerical score indicative of the predicted likelihood of the occurrence of the first event during the first portion of the target interval.

16. The computer-implemented method of claim 12, wherein the trained artificial intelligence process comprises a trained, gradient-boosted, decision-tree process.

17. The computer-implemented method of claim 12, further comprising:
obtaining elements of additional interaction data using the at least one processor, each of the elements of the additional interaction data comprising a temporal identifier associated with a temporal interval;
based on the temporal identifiers, determining, using the at least one processor, that a first subset of the elements of the additional interaction data are associated with a prior training interval, and that a second subset of the elements of the additional interaction data are associated with a prior validation interval; and
using the at least one processor, generating a plurality of training datasets based on corresponding portions of the first subset, and performing operations that train the artificial intelligence process based on the training datasets.

18. The computer-implemented method of claim 17, further comprising:
generating, using the at least one processor, a plurality of validation datasets based on portions of the second subset;
using the at least one processor, applying the trained artificial intelligence process to the plurality of validation datasets, and generating additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validating, using the at least one processor, the trained artificial intelligence process.

19. The computer-implemented method of claim 12, wherein:
the first event occurs when a pendency period associated with an occurrence of a second event during the first portion of the target temporal interval exceeds a threshold period; and
the output data is further representative of the predicted likelihood of (i) the occurrence of the first event during the first portion of the target interval and (ii) a non-occurrence of the second event during the second portion of the target interval; and
the computing system is further configured to perform operations that implement one or more treatment processes in accordance based on the portion of the output data, the implementation of the one or more treatment processes reducing the predicted likelihood of the occurrence of the first event during the first portion of the target interval.

20. A tangible, non-transitory computer-readable medium storing instructions that, when executed by at least one processor, cause the at least one processor to perform a method, comprising:
generating an input dataset based on elements of interaction data associated with an extraction interval;
based on an application of a trained artificial intelligence process to the input dataset, generating output data representative of a predicted likelihood of an occurrence of a first event during a first portion of a target interval, the target interval being subsequent to the extraction interval, the first portion of the target interval being separated from the extraction interval by a second portion of the target interval, and the first event being associated with a predetermined temporal duration within the first portion of the target interval; and
transmitting at least a portion of the generated output data to a computing system, the computing system being configured to perform operations based on the portion of the output data.
